(19) United States
(12) Patent Application Publication
(10) Pub. No.: US 2012/0016633 A1
(43) Pub. Date: Jan. 19, 2012

(54) SYSTEM AND METHOD FOR AUTOMATIC DETECTION OF ANOMALOUS RECURRENT BEHAVIOR

(76) Inventors: Andreas Wittenstein, Woodacre, CA (US); Jim Lloyd, San Francisco, CA (US); Laura Mather, Mountain View, CA (US); Mike Eynon, Mountain View, CA (US)

(21) Appl. No.: 13/184,430

(22) Filed: Jul. 15, 2011

Related U.S. Application Data
(60) Provisional application No. 61/399,714, filed on Jul. 16, 2010.

(51) Int. Cl. G06F 15/00

(52) U.S. Cl. 702/180

(57) ABSTRACT

A non-transitory computer readable storage medium includes executable instructions to observe the distribution of the frequency of a recurrent behavior to form a histogram. A rehistogram of the histogram is computed to model the distribution of the frequency of the frequency of the recurrent behavior. The rehistogram provides an individual frequency relative to the total frequency of the recurrent behavior. The individual frequency is compared to a predicted frequency to form a difference frequency. An anomaly event is identified when the difference frequency exceeds an anomaly threshold.

### CROSS REFERENCE TO RELATED APPLICATIONS

This application claims priority to U.S. Provisional Patent Application 61/399,714, filed Jul. 16, 2010, the contents of which are incorporated herein.

### FIELD OF THE INVENTION

The present invention relates generally to network security. More particularly, the invention relates to behavioral analysis and methods for detecting anomalous or threatening recurrent behavior.

### BACKGROUND OF THE INVENTION

Network security is an ongoing concern. It is desirable to provide increasingly sophisticated network security tools.

### SUMMARY OF THE INVENTION

A non-transitory computer readable storage medium includes executable instructions to observe the distribution of the frequency of a recurrent behavior to form a histogram. A rehistogram of the histogram is computed to model the distribution of the frequency of the frequency of the recurrent behavior. The rehistogram provides an individual frequency relative to the total frequency of the recurrent behavior. The individual frequency is compared to a predicted frequency to form a difference frequency. An anomaly event is identified when the difference frequency exceeds an anomaly threshold.

### BRIEF DESCRIPTION OF THE DRAWINGS

FIG. 1 is a top-level information-flow diagram of an anomalous-behavior detection system according to aspects of the present invention.

FIG. 2 is an information-flow diagram of a behavior recognition system for FIG. 1.

FIG. 3 is a high-level information-flow diagram of a behavior batch explicit recursive histograph for FIG. 1.

FIG. 4 is an information-flow diagram of a behavior×session event histograph for FIG. 3.

FIG. 5 is an information-flow diagram of a behavior×session- or subject-event rehistograph for FIG. 3.

FIG. 6 is an information-flow diagram of a behavior session- or subject-histograph for FIG. 3.

FIG. 7 is an information-flow diagram of a behavior×subject event histograph for FIG. 3.

FIG. 8 is an information-flow diagram of a behavior event histograph for FIG. 3.

FIG. 9 is an information-flow diagram of a behavior×subject or session event rehistogram modeler for the rehistogram modelers in FIG. 1.

FIG. 10 is an information-flow diagram of a session- or subject-rehistogram geometric modeler for FIG. 9.

FIG. 11 is an information-flow diagram of a session- or subject-rehistogram log geometric modeler for FIG. 9.

FIG. 12 is a high-level information-flow diagram of a behavior batch implicit recursive histograph for FIG. 1.

FIG. 13 is an information-flow diagram of a behavior session- or subject-entity event direct histograph for FIG. 12.

FIG. 14 is a high-level information-flow diagram of a behavior adaptive explicit recursive histograph for FIG. 1.

FIG. 15 is an information-flow diagram of a behavior×session- or subject-event adaptive recursive histograph for FIG. 14.

FIG. 16 is an information-flow diagram of a behavior session- or subject-conditional updater for FIG. 15.

FIG. 17 is an information-flow diagram of a behavior session- or subject-event adaptive refrequency updater for FIG. 15.

FIG. 18 is an information-flow diagram of a behavior event adaptive histograph for FIG. 14.

FIG. 19 is a high-level information-flow diagram of a behavior adaptive implicit recursive histograph for FIG. 1.

FIG. 20 is an information-flow diagram of a behavior×session- or subject-event direct adaptive histograph for FIG. 19.

FIG. 21 is an information-flow diagram of a straightforward anomaly computer for FIG. 1.

FIG. 22 is an information-flow diagram of a quick anomaly computer for FIG. 1.

FIG. 23 is an information-flow diagram of a rehistogram frequency linear anomaly estimator for FIG. 21 and FIG. 22.

FIG. 24 is an information-flow diagram of a rehistogram frequency logarithmic anomaly estimator for FIG. 21 and FIG. 22.

FIG. 25 is an information-flow diagram of a behavior session- or subject-event-frequency geometric-distribution linear-probability predictor for FIG. 23 and FIG. 24.

FIG. 26 is an information-flow diagram of a behavior session- or subject-event-frequency geometric-distribution logarithmic-probability predictor for FIG. 23 and FIG. 24.

FIG. 27 is an information-flow diagram of a behavior session- or subject-event-frequency geometric-distribution objective linear-probability predictor for FIG. 23 and FIG. 24.

FIG. 28 is an information-flow diagram of a behavior session- or subject-event-frequency geometric-distribution objective logarithmic-probability predictor for FIG. 23 and FIG. 24.

FIG. 29 is an information-flow diagram of a session- or subject-anomaly evaluator for FIG. 1.

Individual elements of the embodiments are numbered consistently across these figures.

### DETAILED DESCRIPTION OF THE INVENTION

This description presents a system and method for detecting anomalous behavior in situations involving recurrent behavior by multiple subjects or multiple sessions by one subject.

Stochastic repetition of a behavior is often well modeled as a Bernoulli process (the discrete analogue of a Poisson process), where the probability of the behavior being repeated with a particular frequency f is given by the geometric distribution (the discrete analogue of the exponential distribution):

p(f)=r^{f-1}·(1−r)=(1−c)^{f-1}·c

Here the factor r is the common ratio between the probabilities of successive frequencies, and represents the atomic probability of each of the f−1 non-final repetitions, while the factor c=1−r represents the atomic probability of the final fth repetition. That is, at each repetition, r represents the probability of continuing, while its complement, the co-ratio c, represents the probability of stopping.

The expected value of the geometric distribution is equal to the reciprocal of the complement of the common ratio r:

E(f)=1/c=1/(1−r)

Accordingly, given a set of observed behavior-repetition frequencies F={fₛ}, the maximum-likelihood estimate of the ratio parameter of the geometric distribution is given by the complement of the reciprocal of the sample mean:

c=1/μ_{F}

r=1−1/μ_{F}

When comparing different repetition frequencies predicted from a geometric distribution model based on a particular set of observed frequencies, the co-ratio is a constant scaling factor and can be omitted.

On the other hand, the geometric distribution is often misleadingly interpreted as giving the number of Bernoulli trials needed to achieve the first success, where the ratio and co-ratio respectively denote the atomic probability of failure and success. By this interpretation, it may seem that if a sequence of repetitions is halted not because of literal success but for some other reason, then the probability of the last repetition should be accounted as another failure, rather than a success. For example, when a password guesser finally guesses a password or a slot-machine player hits the jackpot, that is clearly a success, whereas either one simply giving up, randomly running out of time or money, or falling asleep would appear to indicate just another failure. Nonetheless, the geometric distribution model is equally valid for any simple complementary termination and continuation criteria, including giving up or not giving up, running out or not running out of money, and falling asleep or staying awake,

However, if there is reason to expect the mode of the distribution to be greater than 1, then the probability of the behavior being repeated f times is given by a 2-parameter generalization of the geometric distribution known as the negative binomial distribution (the discrete analogue of the gamma distribution). For example, in a game where each player needs to successfully execute some action 5 times before proceeding, the expected number of attempts is greater than 1, so a simple geometric distribution is inappropriate, and the negative binomial distribution should be used instead.

Nevertheless, note that if, due to sampling error, the observed mode is greater than 1 even though the expected mode is 1, the geometric-distribution model based on the sample mean still gives good results. As a simple example, if the sample consists of just a single observation with a frequency of 2, then even though the sample mean is 2, the predicted probability of that frequency is quite a bit smaller than 1: p(2)=(1/2)¹·1/2=1/4.

A more-complicated probability distribution may also be appropriate in other situations, such as when other additional constraints are placed on the outcomes. For example, if it is known that subjects are running down a counter, such as when a login mechanism permits a maximum of 5 attempts, then a truncated geometric distribution is more appropriate. If subjects are running down a timer, such as when the anomalous behavior detection itself examines a time-limited window and ignores the possibility of truncating sessions that begin before or end after the time window, a more-complicated model is also required.

Given a histogram record of the observed distribution of the frequency of a recurrent behavior across a population of subjects, sessions, or other entities exhibiting that behavior, the approach disclosed herein models the observed distribution of the frequency of the frequency of the recurrent behavior across the population of frequencies. In this description, a record of a frequency distribution is referred to as a histogram and a record of a frequency distribution of a frequency distribution is referred to as a rehistogram. Conceptually, a rehistogram is akin to a cepstrum, which is a spectrum of a spectrum.

By modeling this second-order distribution as a geometric or other distribution, the invention provides a prediction of the probability, or relative frequency, of each frequency of the recurrent behavior. For each entity, the observed probability of that behavior for that entity—the observed frequency of that behavior for that entity relative to the total frequency of that behavior for all entities of that type—is then compared to the predicted probability of that frequency for that entity type. If the observed probability is greater than the predicted probability, then that entity exhibits that behavior anomalously frequently, and the ratio of the observed relative frequency to the predicted relative frequency—the excess probability—is a measure of the degree of anomaly.

To evaluate the overall anomaly of the behavior of a subject, session, or other entity, the excess probabilities are combined into a joint excess probability by taking the product of the individual excess probabilities for each behavior. In one embodiment, to avoid underflow and simplify computation, the logarithm of the excess probabilities is modeled, and the individual log excess probabilities are combined by summing them. Likewise, in one embodiment, the anomalous behaviors are normalized by accumulating only their excess probabilities rather than their absolute probabilities, in order to avoid underflow when combining the individual probabilities for an entity.

It is tempting to evaluate the overall anomaly of an entity's behavior by simply calculating the cumulative probability of all its individual behaviors. In a certain sense, however, an entity displaying one or more anomalous behaviors behaves anomalously regardless of how many of that entity's other behaviors are normal. In particular, where the detection of anomalous behavior is done to discover threats or risks, it is critical that a threatening entity not be capable of masking its aberrant behavior with any amount of normal behavior. Thus rather than evaluating the overall anomaly of an entity's behavior by estimating the total joint probability of all of its behaviors, in one embodiment only the probabilities of the anomalous behaviors are combined. Specifically, all of an entity's behaviors for which the observed relative frequency is not greater than the predicted relative frequency are ignored.

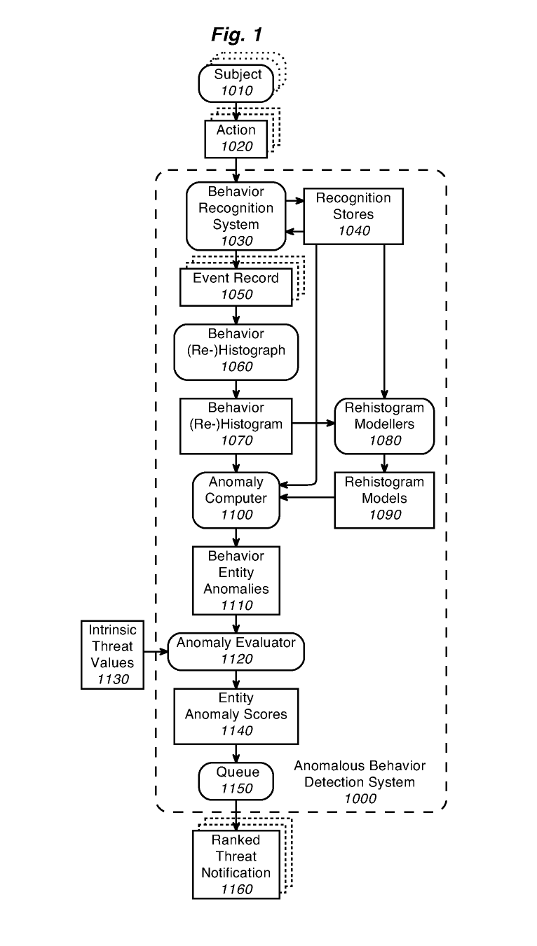

Top-level information-flow diagram FIG. 1 illustrates a typical deployment of the invention. Anomalous-behavior detection system 1000 inputs a multiplicity of actions 1020 produced by one or more subjects 1010, and outputs a set of threat notifications 1160 ranked by threat, as determined by the computed anomalies 1110 in conjunction with intrinsic threat values 1130.

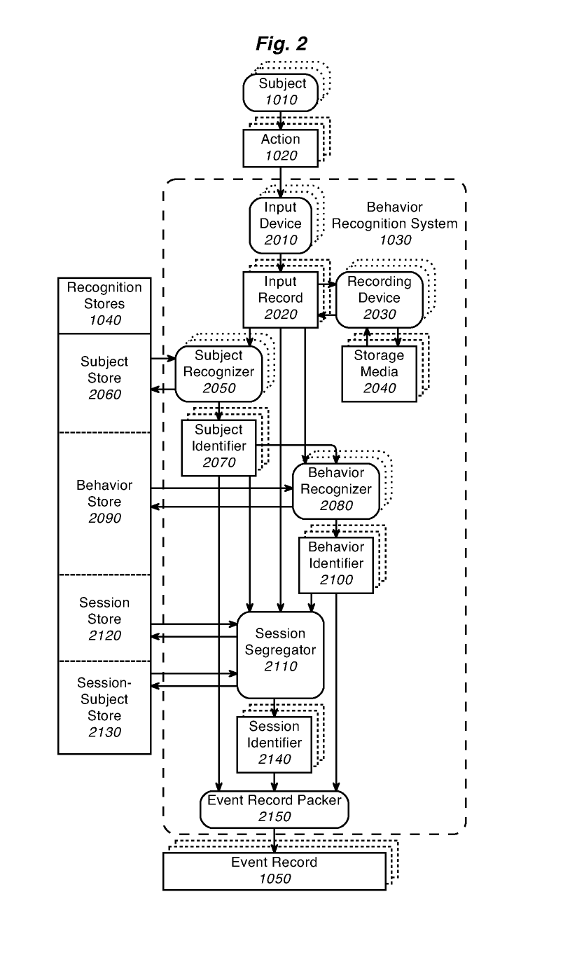

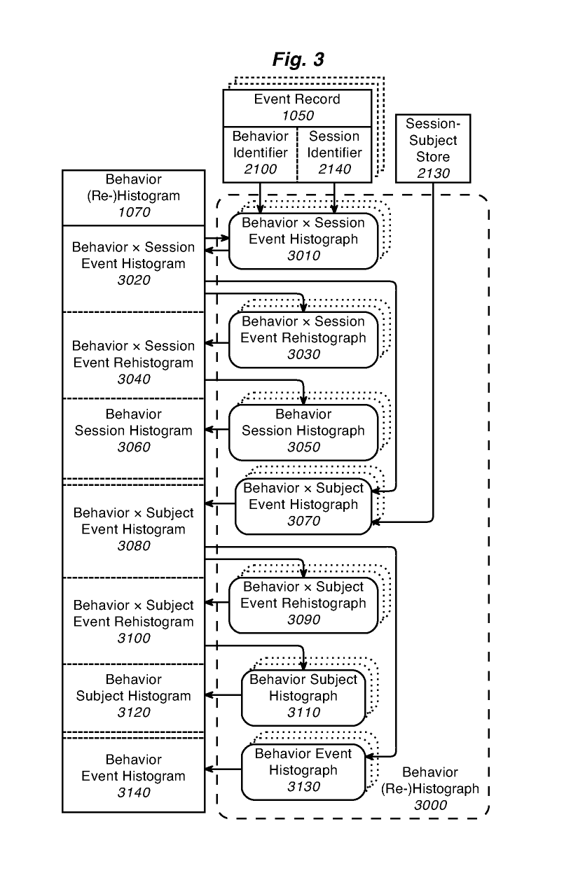

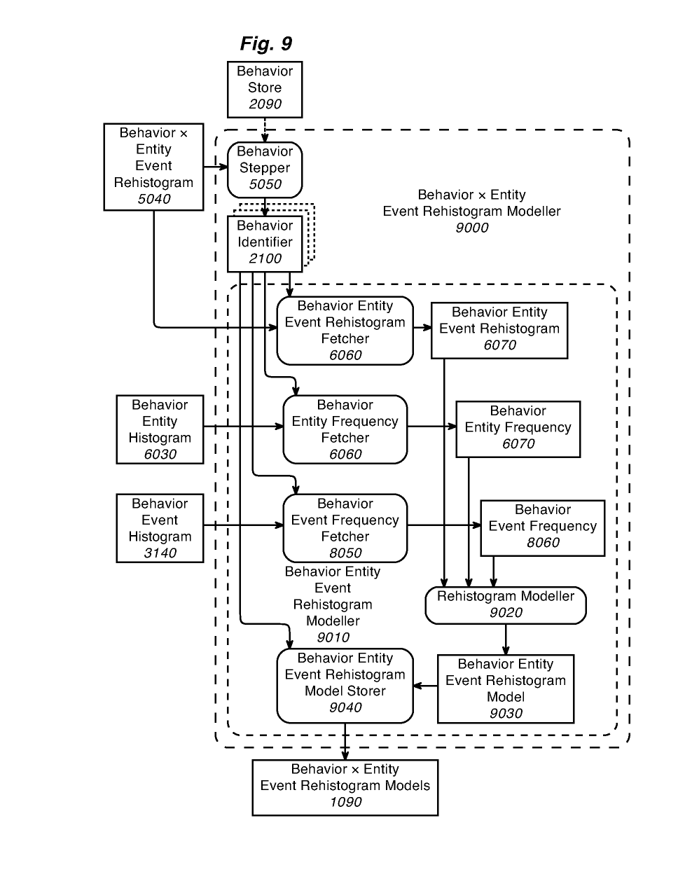

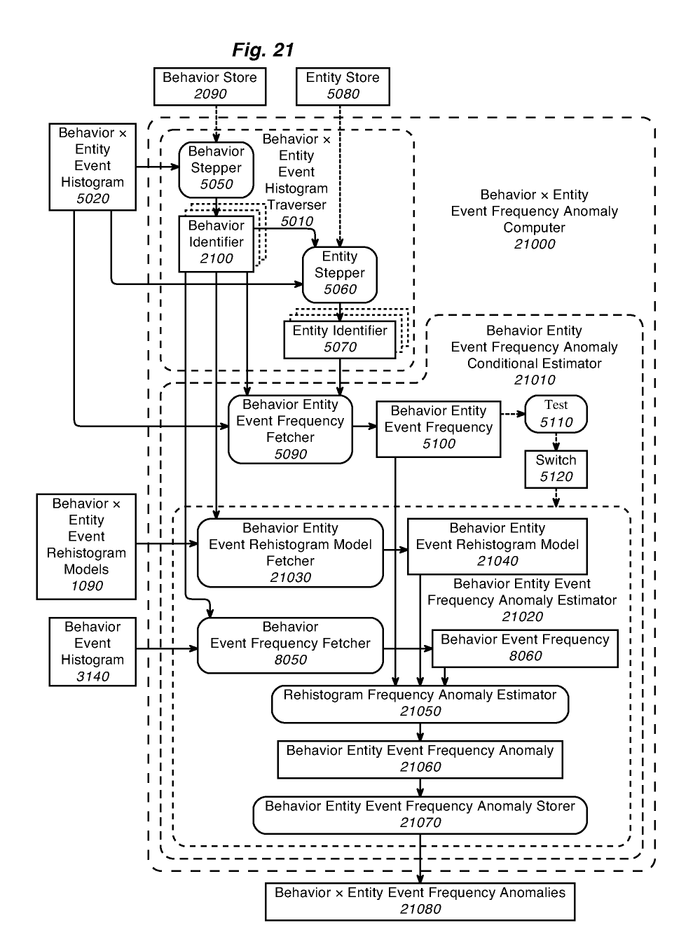

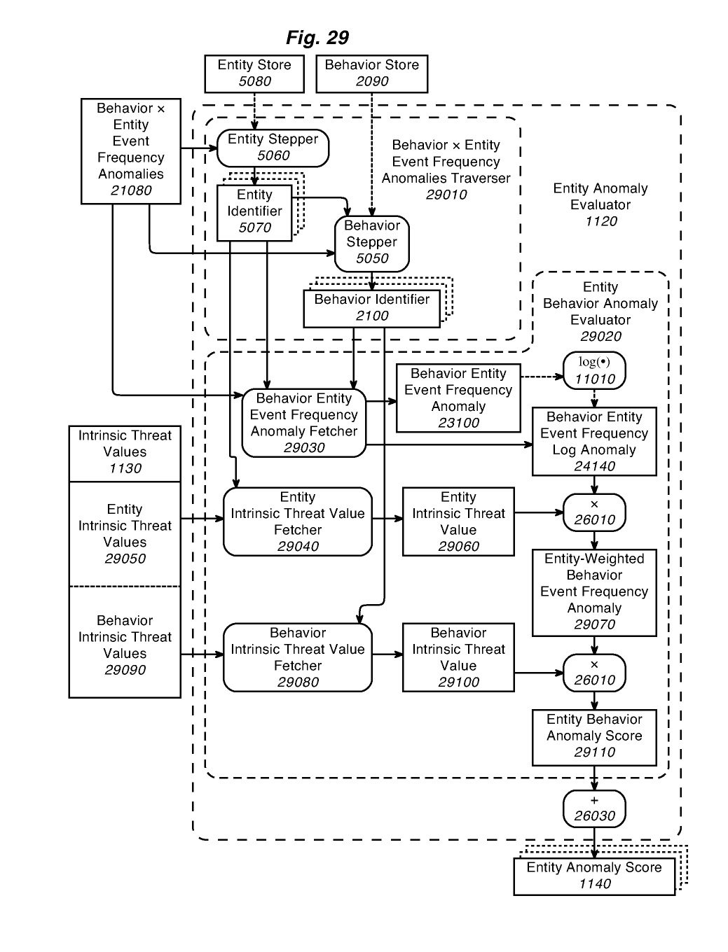

More precisely, subject actions 1020 are first input to behavior recognition system 1030, which parses the actions into events 1050 representing particular behaviors by particular subjects and optionally other entities, with the aid of recognition stores 1040, as described further in connection with FIG. 2. The events are binned by recursive histograph 1060 into recursive histogram 1070, as detailed in FIG. 3 through FIG. 9 and FIG. 12 through FIG. 20. The rehistograms for each behavior are analytically modeled by rehistogram modelers 1080, and output as rehistogram models 1090, as characterized in FIG. 9 through FIG. 11. Anomaly computer 1100 then computes the relative anomaly 1110 of each type of behavior by each subject and optionally other entities, as detailed under FIG. 21 through FIG. 28. Anomaly evaluator 1120 combines the individual behavior anomalies for each subject and each other entity, weighted by intrinsic threat values 1130, into entity-specific anomaly scores 1140, as detailed in FIG. 29. Finally, queue 1150 sorts the entity anomaly scores into ranked threat notifications 1160 to be dealt with in an application-specific manner.

Information-flow diagram FIG. 2 illustrates a typical behavior recognition system 1030 for use in the anomalous-behavior detection system 1000 (See FIG. 1). The behavior recognition system translates the stream of input actions 1020 by subjects 1010 into a stream of events 1050 assigned to individual subjects 2070, behaviors 2100, and sessions 2140 by application-specific subject recognizers 2050, behavior recognizers 2080, and session segregators 2110.

In greater detail, actions 1020 by subjects 1010 are sampled by suitable input devices 2010 to produce input records 2020. It is essential that the sampled subjects 1010 include not just those subjects, if any, suspected of anomalous behavior, but all or a statistically representative cross-section of the subjects compared to whose behavior the behavior of certain subjects may be deemed anomalous. Analogously, it is essential that for each behavior 2100, the sampled actions 1020 include not just those, if any, implicated in instances of suspicious behavior, but all or a statistically representative cross-section of the actions by each subject.

Input records 2020 are stored on storage media 2040 by recording devices 2030, which can be used to replay the actions later as desired. In one embodiment, the behavior recognition system is designed to operate either in real time, recognizing individual subjects, behaviors, and sessions as they occur; or on historical data, by replaying captured actions recorded by the recording devices. In particular, it is often useful to compare current behavior patterns regressively to prior behavior patterns in similar situations, for example at the same phase of known behavioral cycles such as time of day, time of week, time of month, time of season, and time of year. Indeed, through such regressive comparison, the anomalous-behavior detection system described herein may be used to discover such behavioral rhythms.

Subject recognizer 2050 typically identifies the subject(s) 1010 involved in each input action 1020 by comparing each candidate subject's characteristics with those in subject store 2060, outputting resultant corresponding subject identifier(s) 2070 for each input record, updating the subject store as appropriate. The application-specific subject store, part of recognition stores 1040, retains the subject identifier for each subject along with that subject's identifying characteristics. Subjects may, for example, comprise humans or other organisms, organizations, machines, or software. When using the anomalous-behavior detection system to detect anomalous sessions in the behavior of a single known subject or of a group of known subjects whose individual identities are unimportant, the subject recognizer and everything dependent on it, including the subject store and session-subject store, may be omitted for efficiency at the expense of loss of precision and accuracy.

Similarly, behavior recognizer 2080 typically identifies the behavior(s) involved in each input action or sequence of actions 1020 by each subject 1010, as identified by subject identifiers 2070, by comparing each candidate behavior's characteristics with those in behavior store 2090, outputting a corresponding behavior identifier 2100 for each instance of each distinguished behavior by each subject, and updating the behavior store as appropriate. The application-specific behavior store, part of recognition stores 1040, retains each behavior's identifier and identifying characteristics. Behaviors may comprise atomic actions as well as complex probabilistic groups of actions. When detecting anomalous sessions or subjects for a single known behavior or for a group of known behaviors whose individual identity is immaterial, the behavior recognizer and all its dependents, including the behavior store, may be omitted, at the expense of a reduction in precision and accuracy.

For each subject 1010, session segregator 2110 separates the series of behaviors, as identified by behavior identifiers 2100, into individual sessions, for example by comparing each candidate session's characteristics with those in session store 2120, and outputs a corresponding session identifier 2140 and updates session store 2120 as appropriate. The application-specific session store, part of recognition stores 1040, retains each session's identifier and identifying characteristics. In the preferred embodiment, the behavior histograph 1060 (See FIG. 1) takes advantage of the fact that a subject's sessions constitute subsets of that subject's total set of behavior instances, by computing subject behavior event frequencies as marginal values from the session frequencies, rather than tallying them separately. For this purpose, the session segregator also maintains session-subject store 2130, tracking the subject corresponding to each session, as part of the recognition stores. When detecting anomalous subjects in a single known session or in a group of known sessions whose individual identities are inconsequential, the session segregator and all that depends on it, including the session store and session-subject store, may be omitted, at the expense of precision and accuracy.

Finally, for each new subject, session, or behavior instance, event record packer 2150 outputs an event record 1050 containing the subject identifier 2070, behavior identifier 2100, session identifier 2140, and optionally the identifiers of other entities, as needed. In some applications, it may be useful to recognize additional entities, such as supersets or subsets of subjects, behaviors, or sessions. Such additional entities can be straightforwardly accommodated through the same techniques described herein for differentiating between subjects and sessions.

The order of recognition components given here—subject recognizer 2050, behavior recognizer 2080, session segregator 2110—is merely exemplary, and assumes that subjects are at least as easy to recognize as behaviors, which are in turn are no harder to recognize than session boundaries. In applications wherein the behavior is easier to identify than the subject, the behavior recognizer preferably precedes the subject recognizer; and in applications wherein sessions are easier to identify than behaviors or subjects, the session recognizer preferably precedes the behavior recognizer or subject recognizer, respectively. In more complex situations, in applications in which subject recognition and behavior recognition are interdependent, it may be necessary to iterate between subject and behavior recognition or perform simultaneous subject and behavior recognition. Analogously, if the identification of sessions or other entities is interdependent with subjects or behaviors, the respective recognition components may need to be executed iteratively or to be merged.

As an example of the application of a behavior recognition system 1030 in an anomalous behavior detection system 1000, a system for detecting Internet fraud for a bank, e-commerce, or other online site might define subjects as online customers, recognized by their login credentials; behaviors as individual HTTP transactions identified by their URIs; and sessions as login sessions recognized by login and logout transactions. As another example, a system for detecting fraud inside a bank, store, or other institution might define subjects as employees, recognized by their login credentials; behaviors as individual transactions recognized by the forms used; and sessions as workdays.

High-level information-flow diagram FIG. 3 illustrates a batch recursive histograph 3000 for use in the anomalous-behavior detection system 1000 (See FIG. 1). The histograph first bins the input event records 1050 into a behavior×session event histogram 3020, then bins the resulting frequencies into a rehistogram 3040, and subsequently marginalizes the histograms for subjects and overall behaviors.

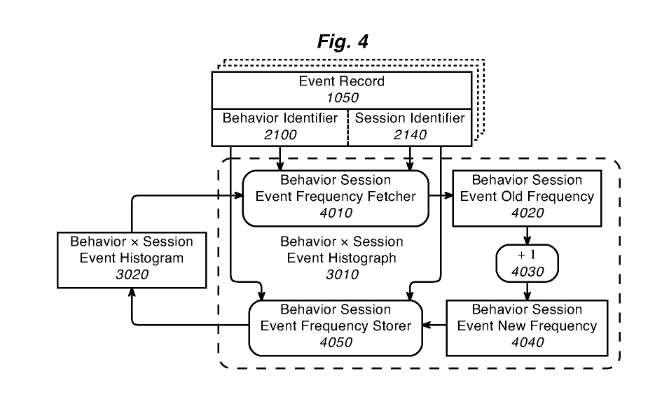

More precisely, behavior recursive histograph 3000 first has behavior×session event histographs 3010 accumulate two-dimensional behavior×session event histogram 3020, whose set of bins is conceptually the product of the set of behaviors and the set of sessions, by tallying the number of event records 1050 for each observed combination of behavior identifier 2100 and session identifier 2140. The behavior×session event histograph is described in further detail under FIG. 4.

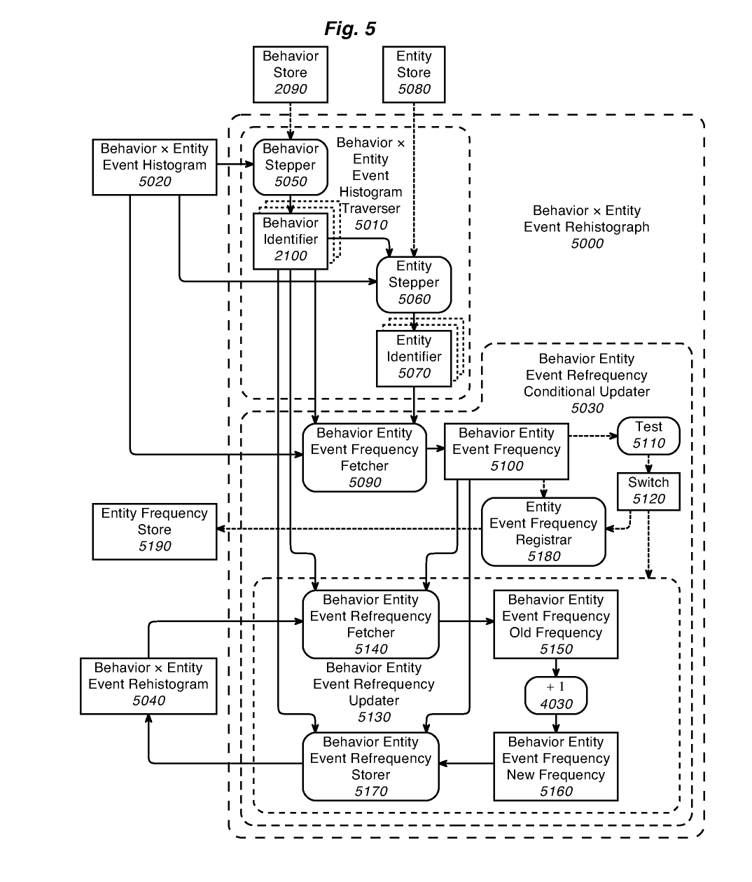

Once behavior×session event histographs 3010 have finished binning the input event records 1050, behavior×session event rehistographs 3030 accumulate two-dimensional behavior×session event rehistogram 3040, whose potential set of bins is the product of the set of behaviors and the set of behavior session event frequencies, by tallying the number of sessions, as identified by session identifiers 2140, for each combination of behavior and behavior session event frequency, where the behavior is identified by behavior identifier 2100, and the behavior session event frequency is given by the number of events recorded in the bin corresponding to that behavior and that session in the behavior×session event histogram. The behavior×session event rehistogram is thus a second-order two-dimensional behavior×session-event-frequency session histogram. The behavior×session event rehistograph is described further under FIG. 5.

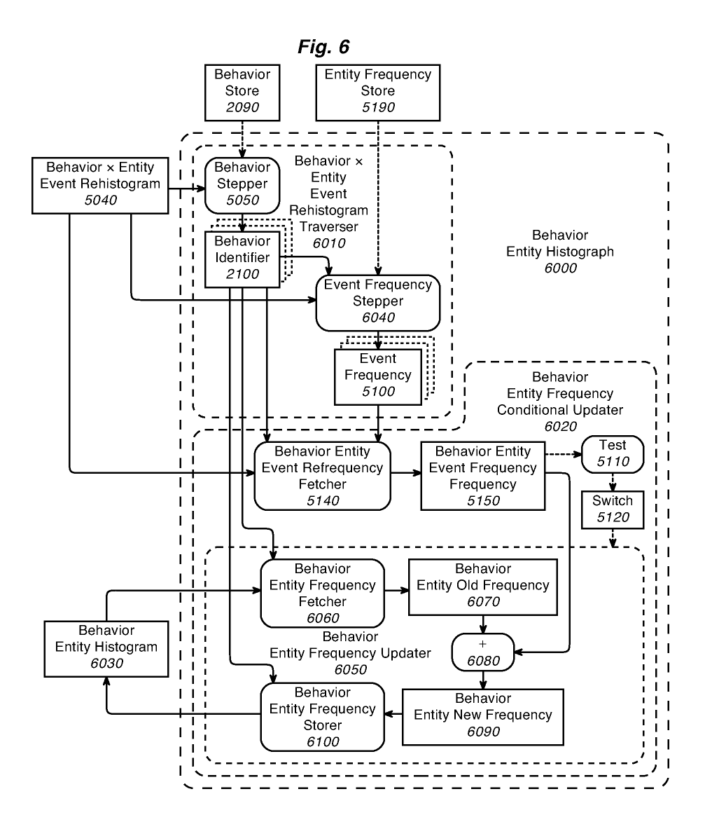

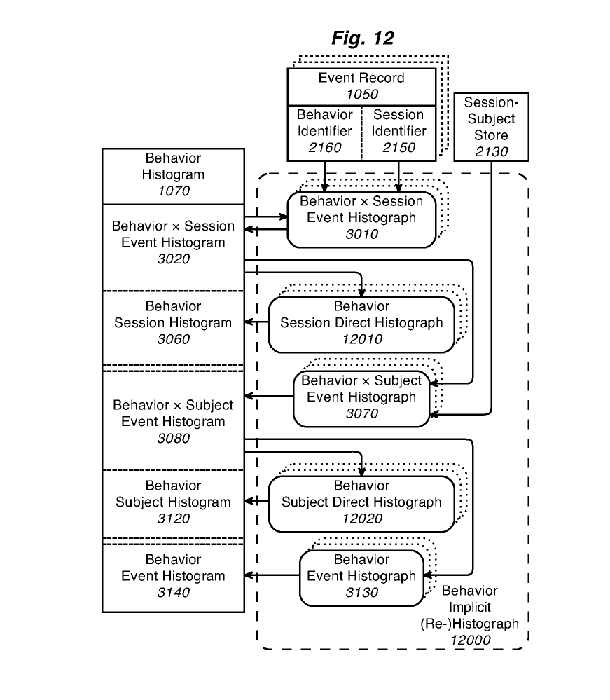

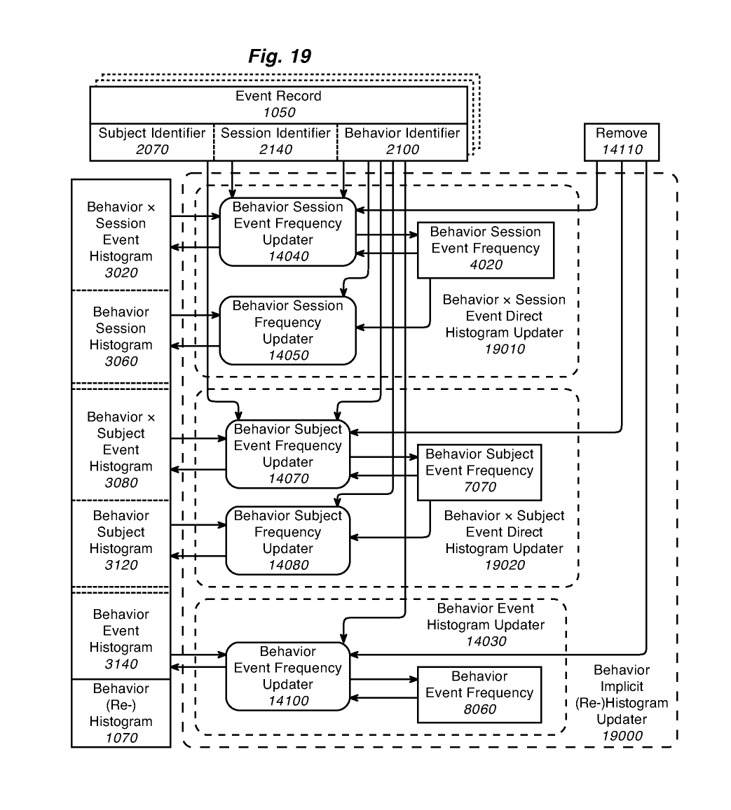

When behavior×session event rehistogram 3040 has been completed, behavior session histographs 3050 accumulate one-dimensional marginal behavior session histogram 3060, whose set of bins is the set of observed behaviors, by, for each behavior, summing the session frequencies across all behavior session event frequencies, where the behavior is identified by behavior identifier 2100, and the session frequency is given by the number of sessions recorded in the bin corresponding to that behavior and that behavior session event frequency in the behavior×session event rehistogram. In an alternative embodiment, the behavior session histographs accumulate the behavior session histogram directly from the behavior×event histogram 3020 (See FIG. 12 and FIG. 19) by tallying, for each behavior, the number of sessions with a nonzero value in the bin corresponding to that behavior and that session in the behavior×session event histogram. Although counting is in principle a simpler operation, summing requires fewer operations, and is thus more efficient when implemented using general-purpose sequential processors, and reduces memory contention in parallel implementations, so in an embodiment, for efficiency, the behavior session histogram is derived from the behavior×session event rehistogram, if available, as shown here. The behavior session histograph is discussed in greater detail in connection with FIG. 6.

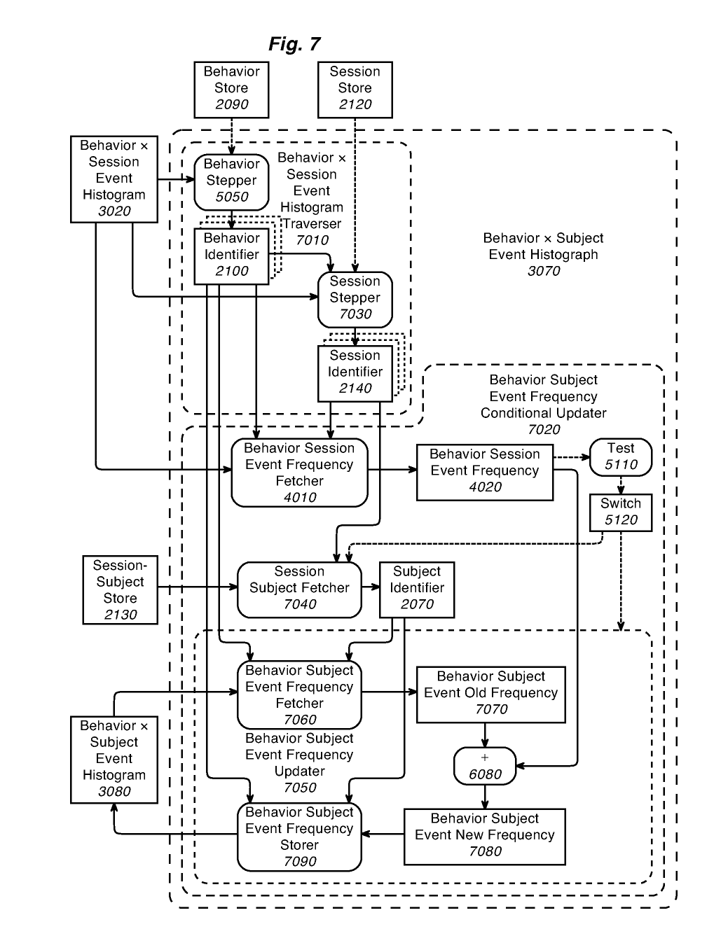

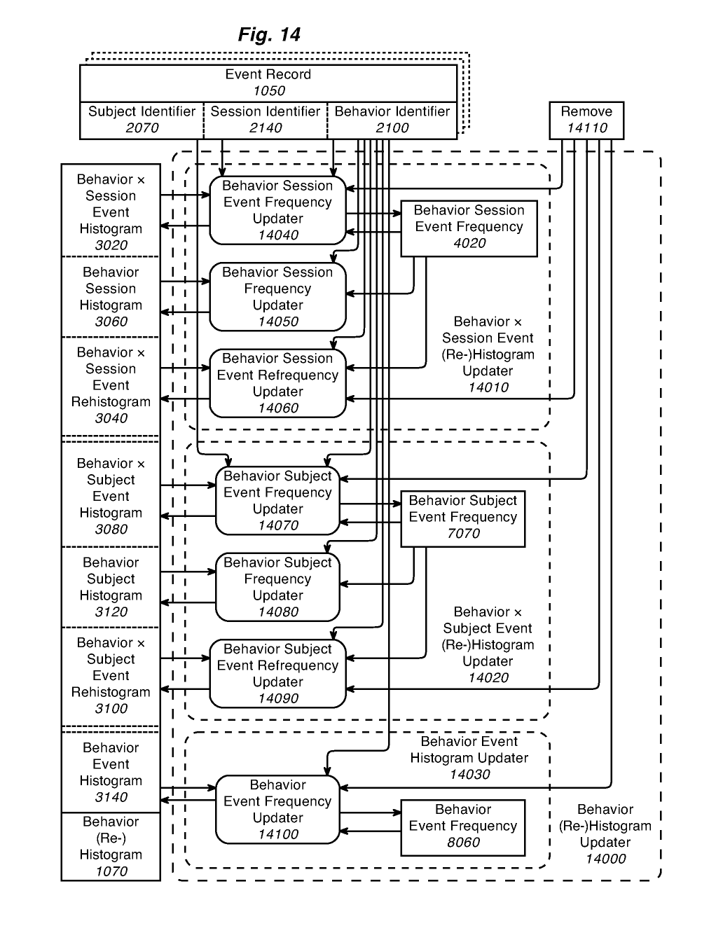

Also after behavior×session event histogram 3020 has been completed, behavior×subject event histographs 3070 accumulate two-dimensional behavior×subject event histogram 3080, whose domain is the product of the set of behaviors and the set of subjects, by, for each behavior and each subject, summing the event frequencies across all sessions for that behavior and that subject, where the subject is identified by looking up the subject identifier 2070 from the session identifier in session-subject store 2130, the session is identified by session identifier 2140, and the event frequency is given by the number of events recorded for that behavior and that session in the behavior×session event histogram. In multiprocessor implementations with sufficient processing power, the behavior×subject event histographs operate concurrently with behavior×session event rehistographs 3030 and behavior session histographs 3050 to reduce the overall execution time. In an alternative embodiment, the behavior×subject event histographs accumulate the behavior×subject event histogram directly from the event records and the session-subject store (See FIG. 14 and FIG. 19) by tallying the number of event records 1050 for each observed combination of behavior identifier 2100 and subject identifier, as identified by looking up session identifier 2140 in the session-subject store; but in the preferred embodiment, to reduce the amount of computation, the behavior×subject event histogram is derived from the behavior×session event histogram, if available, as shown here. The behavior×subject event histograph is detailed in FIG. 7.

Once behavior×subject event histographs 3070 have completed behavior×subject event histogram 3080, behavior×subject event rehistographs 3090 accumulate two-dimensional behavior×subject event rehistogram 3100, whose potential set of bins is the product of the set of behaviors and the set of behavior subject event frequencies, by tallying the number of subjects, as identified by subject identifiers 2070, for each combination of behavior identifier and behavior subject event frequency, where the behavior is identified by behavior identifier 2100, and the behavior subject event frequency is given by the number of events recorded in the bin corresponding to that behavior and that subject in the behavior×subject event histogram. The behavior×subject event rehistogram is thus a second-order two-dimensional behavior×subject-event-frequency subject histogram. The behavior×subject event rehistograph is described in more detail in connection with FIG. 5.

When behavior×subject event rehistogram 3100 is complete, behavior subject histographs 3110 accumulate one-dimensional marginal behavior subject histogram 3060, whose set of bins is the set of observed behaviors, by, for each behavior, summing the subject frequencies across all behavior subject event frequencies, where the behavior is identified by behavior identifier 2100, and the subject frequency is given by the number of subjects recorded in the bin corresponding to that behavior and that behavior subject event frequency in the behavior×subject event rehistogram. In multiprocessor implementations having sufficient processing power, the behavior subject histographs operate concurrently with behavior×subject event rehistographs 3090 to reduce the overall execution time. In an alternative embodiment, the behavior subject histographs accumulate the behavior subject histogram directly from the behavior×event histogram 3020 (See FIG. 12 and FIG. 19) by tallying, for each behavior, the number of subjects with a nonzero value in the bin corresponding to that behavior and that subject in the behavior×subject event histogram; however, in the preferred embodiment, the behavior subject histogram is derived from the behavior×subject event rehistogram, if available, as shown here, to reduce the amount of computation. The behavior subject histograph is described further under FIG. 6.

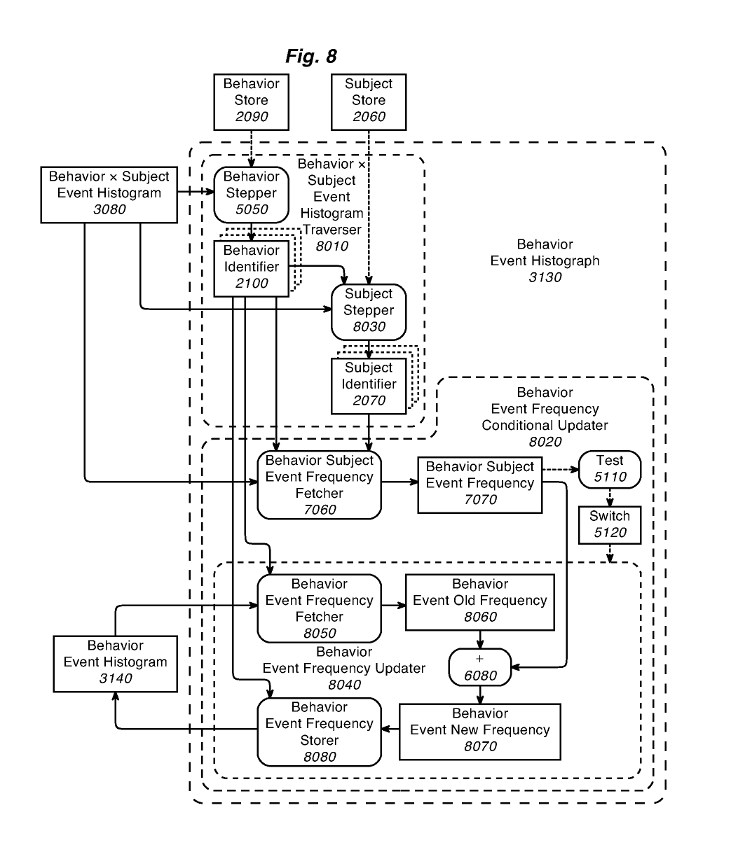

Finally, also once behavior×subject event histogram 3080 is complete, behavior event histographs 3130 accumulate one-dimensional marginal behavior event histogram 3140, whose set of bins is the set of observed behaviors, by, for each behavior, summing the behavior subject event frequencies across all subjects, where the behavior is identified by behavior identifier 2100, and the behavior subject frequency is given by the number of events recorded in the bin corresponding to that behavior and that subject in the behavior×subject event histogram. In sufficiently powerful multiprocessor implementations, the behavior event histographs operate concurrently with behavior×subject event rehistographs 3090 and behavior subject histographs 3110 to reduce the overall execution time. In an alternative embodiment, the behavior event histographs accumulate the behavior event histogram directly from behavior session event histogram 3020, by, for each behavior, summing the behavior session event frequencies across all sessions, where the behavior is identified by the behavior identifier, and the behavior session frequency is given by the number of events recorded in the bin corresponding to that behavior and that session in the behavior×session event histogram; but in the preferred embodiment, the behavior event histogram is derived from the behavior×subject event histogram, as shown here, if available, to reduce the amount of computation. In another alternative embodiment, the behavior event histogram is derived directly from the event records 1050 (See FIG. 14 and FIG. 19), by tallying the number of event records 1050 for each observed behavior. The behavior event histograph is detailed under FIG. 8.

The component histograms—behavior×session event histogram 3020, behavior×session event rehistogram 3040, behavior session histogram 3060, behavior×subject event histogram 3080, behavior×subject event rehistogram 3100, behavior subject histogram 3120, and behavior event histogram 3140—are all part of behavior recursive histogram 1070. The component histograms may be stored either as separate histograms or combined into a single composite histogram, depending not only on the computational efficiency of the anomalous behavior detection system, but also on the lifetime of the several component histograms and the other uses to which they are put. In embodiments using sparse histograms, it may also be convenient to combine the histograms with the recognition stores 1040 (See FIG. 2) in a single composite structure.

In applications wherein the number of subjects, the number of behaviors, and the number of sessions are all known in advance, and in which most subjects exhibit most behaviors in most sessions, resulting in densely populated histograms, an embodiment represents the histograms 1070 as complete linear arrays, and represents the subject identifiers 2070, behavior identifiers 2100, and session identifiers 2140 as nonnegative ordinal integers, such that session identifiers serve as direct indices into the session dimension of the behavior×session event histogram 3020, subject identifiers serve as direct indices into the subject dimension of the behavior×subject event histogram 3080, and the behavior identifier serves as a direct index into the behavior dimensions of each histogram, to maximize memory usage efficiency.

On the other hand, in applications wherein the number of subjects, the number of behaviors, or the number of sessions are not known in advance, or in which most subjects do not exhibit most behaviors in most sessions, the preferred embodiment represents the histogram as a sparse array, allocating memory only for bins representing actually observed cases, where the subject identifier 2070 is an arbitrary unique key based on the subject's identifying characteristics, the behavior identifier is an arbitrary unique key 2080 based on the behavior's identifying characteristics, and the session identifier 2140 is an arbitrary unique key based on the session's identifying characteristics, again to maximize memory usage efficiency. Although in general any type of sparse array technology may be used, such as hash tables, trees, or linked lists, the optimal technology is optimized primarily for random read and write access, secondarily for insertion, with deletion less important; among currently available sparse-array technologies, therefore, an embodiment employs Judy arrays. A Judy array is a complex, fast associative array data structure that stores and looks up values using integer or string keys. Unlike normal arrays, Judy arrays may have large ranges of unassigned indices. Judy arrays are designed to keep the number of processor cache-line fills as low as possible. Due to the cache optimizations, Judy arrays are fast, sometimes even faster than a hash table, particularly for very large datasets. For each type of entity, the key may, for example, be an ordinal number, the name of the entity, or a hash of a number of distinguishing characteristics, depending on the particulars of the application.

Alternatively, if the cardinality of only one or some of the marginal sets—subjects 2070, behaviors 2100, sessions 2140, and other optional entities—is known in advance or is well-bounded, then that dimension or those dimensions may be represented by complete arrays while the others are represented by sparse arrays. As another alternative embodiment, if the cardinality of all the marginal sets is known in advance or is well-bounded, but the two-dimensional histograms (behavior×session event histogram 3020, behavior×session event rehistogram 3040, behavior×subject event histogram 3080, and behavior×subject event rehistogram 3100,) are nonetheless sparsely populated, as is commonly the case, then the individual dimensions many be represented by complete arrays while the two-dimensional histograms are represented as sparse arrays. More generally, a complete or sparse representation may be chosen independently for each dimension in each histogram, albeit at the cost of increased complexity.

For embodiments employing multidimensional histogram technologies having an intrinsic access dominance ranking among dimensions, such as trees and linear arrays, in the preferred embodiment the major dimension for the two-dimensional component histograms—behavior×session event histogram 3020, behavior×session event rehistogram 3040, behavior×subject histogram 3080, and behavior×subject event rehistogram 3100—is chosen to be behavior, being the common dimension among all the component histograms, and in order to facilitate rehistogram modeling, as described under FIG. 9.

In multiprocessor implementations, the preferred embodiment employs multiple copies of each component histograph (behavior×session event histograph 3010, behavior×session event rehistograph 3030, behavior session histograph 3050, behavior×subject event histograph 3070, behavior×subject event rehistograph 3090, behavior subject histograph 3050, and behavior event histograph 3130), as shown, and implements the histograms 1070 as sparse arrays to facilitate locking local regions of the histogram to avoid memory contention. In an alternative embodiment, a complete linear array is used, with locks on rows, individual bins, or otherwise partitioned regions of the histograms. Moreover, in parallel-processing embodiments, when updating the contents of a sparse element, the fetching, incrementing, and storing are performed in a single atomic operation to avoid collisions.

In multiprocessor implementations, an embodiment disperses the keys (subject identifiers 2070, behavior identifiers 2100, and session identifiers 2140) for each entity type with a hash function to facilitate balanced sharding of the data among processors in such a way as to maximize use of all processors while minimizing histogram memory-access collisions.

For histograms represented as complete arrays, the respective component histographs or high-level behavior recursive histographs 3000 initialize all frequencies to zero (0) before beginning to accumulate observations. For histograms represented as sparse arrays, on the other hand, a nonexistent bin implies a frequency of zero, and each component histograph typically only creates and initializes each bin upon the first observation falling into that bin.

In one embodiment, all frequencies in the anomalous behavior detection system 1000 are represented as nonnegative integers of sufficient precision to represent the application-specific highest observable frequency without danger of overflow.

Information-flow diagram FIG. 4 illustrates a batch behavior×session event histograph 3010 for use in behavior recursive histograph 3000 (see FIG. 3). The behavior×session event histograph inputs event records 1050, and for each input record, increments the frequency of that event in the bin corresponding to the behavior identifier 2100 and session identifier 2140 associated with that event in behavior×session event histogram 3020. In detail, for each input event record 1050, behavior session event frequency fetcher 4010 fetches, from the behavior×session event histogram, the behavior session event frequency 4020 corresponding to the behavior identifier and session identifier given by the event record. Frequency incrementer 4030 increases the behavior session event frequency by one (1), indicating one additional observation of that combination of behavior and session, and outputs the result as increased behavior session event frequency 4040. Behavior session event frequency storer 4050 stores the updated frequency 4040 in the bin corresponding to the behavior and session in the behavior×session event histogram. In embodiments using a sparse representation of the behavior×session event histogram, if that bin does not yet exist, then the behavior session event frequency storer first creates it and inserts it in the histogram.

Information-flow diagram FIG. 5 illustrates a batch behavior×entity event rehistograph 5000 for use in behavior recursive histograph 3000 (See FIG. 3), where the entities are either sessions, corresponding to behavior×session event rehistograph 3030; subjects, corresponding to behavior×subject rehistograph 3050; or any additional entity type required for the specific application. Behavior×entity event histogram traverser 5010 steps through the bins in behavior×entity event histogram 5020, which is either behavior×session event histogram 3020, or behavior×subject event histogram 3080, respectively. For each bin with a nonzero frequency, behavior entity event refrequency conditional updater 5030 increments the corresponding bin in behavior×entity event rehistogram 5040, which is either behavior×session event rehistogram 3040 or behavior×subject event rehistogram 3100, respectively.

More specifically, in behavior×entity event histogram traverser 5010, behavior stepper 5050 steps through the set of behaviors in behavior×entity event histogram 5020, outputting each one as a behavior identifier 2100. For each behavior, entity stepper 5060 steps through the set of entities for that behavior in the behavior×entity event histogram, outputting each one as an entity identifier 5070, which is either a session identifier 2140 or a subject identifier 2070 (See FIG. 2), respectively. In the preferred embodiment, the behavior stepper precedes the entity stepper, as depicted here, corresponding to the preferred behavior-major orientation of the behavior×entity event histogram. For a behavior-minor histogram, the preferred embodiment traverses the histogram by entity first instead.

In embodiments wherein the set of actually observed behaviors is not immediately given by behavior×entity event histogram 5020 itself, for example if the behavior dimension of the histogram is represented as a linear array of all potentially observable behaviors, in an embodiment, behavior stepper 5050 steps through all and only the actually observed behaviors as given by behavior store 2090, rather than through all possible behaviors. Likewise, in an embodiment, if the set of actually observed entities of a given entity type is not given by the histogram itself, then entity stepper 5060 steps through only the actually observed entities as given by entity store 5080, which is either session store 2120 or subject store 2060, respectively.

In behavior entity event refrequency conditional updater 5030, behavior entity event frequency fetcher 5090 fetches the behavior entity event frequency 5100 corresponding to behavior identifier 2100 and entity identifier 5070 from behavior×entity event histogram 5020 and inputs it to behavior entity event refrequency updater 5130.

In embodiments wherein the set of actually observed combinations of behavior identifier 2100 and entity identifier 5070 is not immediately given by the behavior×entity event histogram 5020 itself, for example if the histogram is represented as a complete array of the product of all actually observed behaviors and all actually observed entities, frequency test 5110 checks each behavior entity event frequency 5100, setting switch 5120 accordingly to execute behavior entity event refrequency updater 5130 if and only if the behavior entity event frequency is nonzero.

For each input combination of behavior identifier 2100 and behavior entity event frequency 5100, behavior entity event refrequency updater 5130 increments the frequency in the bin corresponding to that behavior identifier and that behavior entity event frequency in behavior×entity event rehistogram 5040. In detail, behavior entity event refrequency fetcher 5140 fetches, from the behavior×entity event rehistogram, the behavior entity event frequency frequency 5150 corresponding to the input behavior identifier and behavior entity event frequency—that is, it fetches the frequency of the frequency of that behavior among all entities so far of that type. Frequency incrementer 4030 increases the behavior event frequency frequency by one (1) to indicate an additional observation of that combination of behavior and behavior entity event frequency, outputting the result as increased behavior entity event frequency new frequency 5160. Behavior entity event refrequency storer 5170 stores the updated behavior entity event frequency new frequency in the bin corresponding to the behavior and behavior entity event refrequency in the behavior×entity event rehistogram. In embodiments using a sparse representation of the behavior×entity event rehistogram, if that bin does not exist yet, it is first created and inserted.

In embodiments wherein the set of actually observed event frequencies 5100 is not immediately given by the behavior×entity event rehistogram 5020 itself, in an embodiment entity event frequency registrar 5180 records each actually observed event frequency as determined by switch 5120, for the entity type in entity frequency store 5190, to reduce the subsequent time spent searching for positive event frequencies in behavior entity rehistograph 6000 (See FIG. 6) and other tasks.

Where minimizing the amount of computation takes precedence over minimizing execution time, in an embodiment switch 5120 turns on or off the entire behavior entity event refrequency updater 5130, as shown. But where processing speed takes precedence over the amount of processing, in an embodiment behavior entity event refrequency fetcher 5140 prefetches behavior entity event frequency old frequency 5150 concurrently as behavior entity event frequency fetcher 5090 fetches behavior entity event frequency 5100, so that the switch affects only frequency incrementer 4030 and behavior entity event refrequency storer 5170 within the behavior entity event refrequency updater, which therefore does not need to wait for the determination of frequency test 5110 in order to begin operation in case the behavior entity event frequency turns out to be nonzero.

Information-flow diagram FIG. 6 illustrates a batch behavior entity histograph 6000 for use in behavior recursive histograph 3000 (See FIG. 3), where the entities are either sessions, corresponding to behavior session histograph 3050; subjects, corresponding to behavior subject histograph 3110; or any additional entity type the specific application requires. Behavior×entity event rehistogram traverser 6010 steps through the bins in behavior×entity event rehistogram 5040, which is either behavior×session event rehistogram 3040, or behavior×subjection event rehistogram 3100, respectively. For each bin with a nonzero frequency, behavior entity frequency conditional updater 6020 adds the frequency in that bin to the corresponding bin in behavior entity histogram 6030, which is either behavior session histogram 3060 or behavior subject histogram 3120, respectively.

More precisely, in behavior×entity event rehistogram traverser 6010, behavior stepper 5050 steps through the set of behaviors in behavior×entity event rehistogram 5040, outputting each as a behavior identifier 2100. For each behavior, event frequency stepper 6040 steps through the set of event frequencies for that behavior in the behavior×entity event rehistogram, outputting each as an event frequency 5100. In the preferred embodiment, as illustrated here, the behavior stepper precedes the event frequency stepper, in accordance with the preferred behavior-major orientation of the behavior×entity rehistograms. The preferred embodiment for a behavior-minor rehistogram traverses the rehistogram by event frequency first.

In embodiments wherein the set of actually observed behaviors is not immediately provided by behavior×entity event rehistogram 5040 on its own, in an embodiment behavior stepper 5050 steps through just the actually observed behaviors as given by behavior store 2090, instead of through all possible behaviors. Likewise, in an embodiment, if the set of actually observed event frequencies for a given entity type is not given by the rehistogram on its own, then entity frequency stepper 6040 steps through just the actually observed entity frequencies as given by entity frequency store 5190.

In behavior entity frequency conditional updater 6020, behavior entity event refrequency fetcher 5140 fetches the behavior entity event frequency frequency 5150 corresponding to behavior identifier 2100 and event frequency 5100 from behavior×entity event rehistogram 5040 and inputs it to behavior entity frequency updater 6050.

In embodiments wherein the set of actually observed combinations of behavior identifier 2100 and event frequency 5100 is not immediately provided by the behavior×entity event rehistogram 5040 on its own, for example if the rehistogram is represented as a complete array of the product of all actually observed behaviors and all actually observed event frequencies for that type of entity, in an embodiment frequency test 5110 checks each behavior entity event frequency frequency 5150, and sets switch 5120 accordingly to execute behavior entity frequency updater 6050 only if the behavior entity event frequency frequency is not zero, to reduce the amount of computation.

For each input combination of behavior identifier 2100 and behavior entity event frequency frequency 5150, behavior entity frequency updater 6050 adds that behavior entity event frequency frequency to the frequency in the bin corresponding to that behavior identifier in behavior entity histogram 6030. More precisely, behavior entity frequency fetcher 6060 fetches, from the behavior entity histogram, the behavior entity frequency 6070 corresponding to the input behavior identifier—that is, it fetches the frequency of that behavior among all entities so far of that type. Frequency adder 6080 increases the behavior entity frequency by the behavior entity event frequency frequency to denote that number of additional entities exhibiting that behavior, outputting the result as increased behavior entity frequency 6090. Behavior entity frequency storer 6100 stores the updated behavior entity frequency in the bin corresponding to that behavior in the behavior entity histogram. In embodiments using a sparse representation of the behavior entity histogram, if that bin does not already exist, the behavior entity frequency storer first creates it and inserts it in the histogram.

In applications where minimizing the amount of computation is more important than minimizing the execution time, in an embodiment switch 5120 switches on or off the entire behavior entity frequency updater 6050, as shown. But where computational speed is more important than the amount of computation, in an embodiment behavior entity frequency fetcher 6060 prefetches behavior entity old frequency 6070 concurrently while behavior entity event refrequency fetcher 5140 fetches behavior entity event frequency frequency 5150, so that the switch only affects frequency adder 6080 and behavior entity frequency storer 6100 within the behavior entity frequency updater, which thus does not need to wait for the determination of frequency test 5110 prior to beginning operation in case the behavior entity event frequency frequency is nonzero.

Information-flow diagram FIG. 7 illustrates a batch behavior×subject event histograph 3070 for use in behavior recursive histograph 3000 (See FIG. 3). Behavior×session event histogram traverser 7010 steps through the bins in behavior×session event histogram 3020, and for each bin with a positive frequency, behavior subject event frequency conditional updater 7020 adds the frequency in that bin to the corresponding bin in behavior×subject event histogram 3080.

In detail, in behavior×session event histogram traverser 7010, behavior stepper 5050 steps through the set of behaviors in behavior×session event histogram 3020, and outputs each one as a behavior identifier 2100. For each behavior, session stepper 7030 steps through the set of sessions for that behavior in the behavior×session event histogram, and outputs each one as a session identifier 2140. In an embodiment, as depicted here, the behavior stepper precedes the session stepper, corresponding to the preferred behavior-major orientation of the behavior×session event histogram. In the case of a behavior-minor rehistogram, an embodiment traverses the histogram by session first instead.

In embodiments wherein behavior×session event histogram 3020 does not itself provide the set of actually observed behaviors, in an embodiment behavior stepper 5050 only steps through the actually observed behaviors as specified by behavior store 2090, rather than stepping through all possible behaviors. Likewise, in an embodiment, if the set of actually observed sessions is not provided by the histogram itself, session stepper 7030 only steps through the actually observed sessions as specified by session store 2120.

In behavior subject event frequency conditional updater 7020, behavior session event frequency fetcher 4010 fetches the behavior session event frequency 4020 corresponding to behavior identifier 2100 and session identifier 2140 from behavior×session event histogram 3020 and inputs it to behavior subject event frequency updater 7050; while session subject fetcher 7040 fetches the subject identifier 2070 corresponding to session identifier 2140 from session-subject store 2130, and likewise inputs it to the behavior subject event frequency updater.

In embodiments in which the behavior×session event histogram 3020 itself does not provide the set of actually observed combinations of behavior identifier 2100 and session identifier 2140, in an embodiment, for computational efficiency frequency test 5110 checks each behavior session event frequency 4020, and sets switch 5120 to only run behavior subject event frequency updater 7050 and session subject fetcher 7040 if the behavior session event frequency is positive.

For each input combination of behavior identifier 2100 behavior session event frequency 4020, and subject identifier 2070, behavior subject event frequency updater 7050 adds that frequency to the frequency in the bin corresponding to that behavior identifier and input subject identifier in behavior×subject event histogram 3080. More specifically, behavior subject event frequency fetcher 7060 fetches, from the behavior×session event histogram, the behavior subject event frequency 7070 corresponding to the input behavior identifier and subject identifier—that is, it fetches the frequency of that behavior among all sessions so far for that subject. Frequency adder 6080 increases the behavior subject event frequency by the behavior session event frequency to indicate that many additional observations of that combination of behavior and subject, outputting the result as increased behavior subject event frequency 7080. Behavior subject event frequency storer 7090 stores the updated behavior subject event frequency in the bin corresponding to the behavior and subject in the behavior×subject event histogram. In embodiments using a sparse representation of the behavior×subject event histogram, if that bin does not yet exist, it is first created and inserted.

In applications where minimizing the amount of processing is more critical than maximizing processing speed, in an embodiment, as depicted here, switch 5120 toggles both the session subject fetcher 7040 and the entire behavior subject event frequency updater 7050. But where computational speed is more critical, in an embodiment behavior subject event frequency fetcher 7060 prefetches behavior subject event old frequency 7070 concurrently while behavior session event frequency fetcher 4010 fetches behavior session event frequency 4020 and the session subject fetcher fetches subject identifier 2070, so that the switch only toggles frequency adder 6080 and behavior subject event frequency storer 7090 within the behavior subject event frequency updater, which thus does not have to wait for the determination of frequency test 5110 before beginning operation in case the behavior session event frequency is positive.

Information-flow diagram FIG. 8 illustrates a batch behavior event histograph 3130 for use in behavior recursive histograph 3000 (See FIG. 3). Behavior×subject event histogram traverser 8010 steps through the bins in behavior×subject event histogram 3080, and for each bin with a positive frequency, behavior event frequency conditional updater 8020 adds the frequency in that bin to the corresponding bin in behavior event histogram 3140.

In greater detail, in behavior×subject event histogram traverser 8010, behavior stepper 5050 steps through the set of behaviors in behavior×subject event histogram 3080, outputting each one as a behavior identifier 2100. For each behavior, subject stepper 8030 steps through the set of subjects in the behavior×subject event histogram, outputting each one as a subject identifier 2070. In an embodiment, as shown here, the behavior stepper precedes the subject stepper, in alignment with the preferred behavior-major orientation of the behavior×subject event histogram. For a histogram with a behavior-minor access orientation, an embodiment traverses the rehistogram by subject first.

In embodiments in which behavior×subject event histogram 3080 on its own does not furnish the set of actually observed behaviors, in an embodiment behavior stepper 5050 steps through only the actually observed behaviors as given by behavior store 2090, rather than through all possible behaviors. Likewise, in an embodiment, if the histogram on its own does not furnish the set of actually observed subjects, subject stepper 8030 steps through only the actually observed subjects as given by subject store 2060.

In behavior event frequency conditional updater 8020, behavior subject event frequency fetcher 7060 fetches the behavior subject event frequency 7070 corresponding to behavior identifier 2100 and subject identifier 2070 from behavior×subject event histogram 3080 and inputs it to behavior event frequency updater 8040.

In embodiments in which the behavior×subject event histogram 3080 on its own does not furnish the set of actually observed combinations of behavior identifier 2100 and subject identifier 2070, in an embodiment frequency test 5110 checks each behavior subject event frequency 7070, setting switch 5120 accordingly to only execute behavior event frequency updater 8040 if the behavior subject event frequency is nonzero, to avoid unnecessary computation.

For each input behavior identifier 2100 and behavior subject event frequency 7070, behavior event frequency updater 8040 adds that frequency to the frequency in the bin corresponding to that behavior identifier in behavior event histogram 3140. In detail, behavior event frequency fetcher 8050 fetches, from the behavior event histogram, the behavior event frequency 8060 corresponding to the input behavior identifier—that is, it fetches the frequency of that behavior among all events observed so far. Frequency adder 6080 increases the behavior event frequency by the behavior subject event frequency, denoting that number of additional observations of that behavior, outputting the result as increased behavior event frequency 8070. Behavior event frequency storer 8080 stores the updated behavior event frequency in the bin corresponding to the behavior in the behavior event histogram. In embodiments employing a sparse representation of the behavior event histogram, if that bin does not yet exist, the behavior entity frequency storer first creates and inserts it.

In applications wherein optimizing total computation is more important than optimizing the processing speed, in an embodiment switch 5120 switches on or off the entire behavior event frequency updater 8040, as shown. But where processing speed is more important than computational burden, in an embodiment behavior event frequency fetcher 8050 presumptively fetches behavior event old frequency 8060 concurrently as behavior subject event frequency fetcher 7060 fetches behavior subject event frequency 7070, so that the switch only controls frequency adder 6080 and behavior event frequency storer 8080, and the behavior event frequency updater does not need to wait for the outcome of frequency test 5110 to begin operation in case the behavior subject event frequency is positive.

Information-flow diagram FIG. 9 illustrates a behavior×entity event rehistogram modeler 9000 for use in anomalous behavior detection system 1000 (See FIG. 1), where the entities are either sessions, resulting in behavior×session entity event rehistogram models; subjects, resulting in behavior×subject entity event rehistogram models; or any other entity required for the specific application. Behavior stepper 5050 steps through the behavior entity event rehistograms in behavior×entity event rehistogram 5040, which are either behavior session event rehistograms 3040 or behavior subject event rehistograms 3100, respectively, and for each behavior, behavior entity event rehistogram modeler 9010 models the distribution of behavior entity event frequency frequencies for that behavior across all behavior entity event frequencies, outputting the resulting models as behavior×entity event rehistogram models 1090, which are either behavior×session event rehistogram models or behavior×subject event rehistogram models, respectively.

More specifically, behavior stepper 5050 steps through the set of behaviors in behavior×entity event rehistogram 5040, outputting each as a behavior identifier 2100. For each behavior, event frequency stepper 6040 steps through the set of event frequencies for that behavior in the behavior×entity event rehistogram, outputting each as an event frequency 5100. In embodiments wherein the set of actually observed behaviors is not immediately provided by the behavior×entity event rehistogram on its own, in the preferred embodiment, for efficiency, behavior stepper 5050 steps through just the actually observed behaviors as given by behavior store 2090, instead of through all possible behaviors.

In behavior entity event rehistogram modeler 9010, behavior entity event rehistogram fetcher 6060 fetches behavior entity event rehistogram 6070 corresponding to behavior identifier 2100 from behavior×entity event rehistogram 5040, and inputs it to rehistogram modeler 9020; while behavior entity frequency fetcher 6060 fetches behavior entity frequency 6070 corresponding to the behavior identifier from behavior entity histogram 6030 and inputs it to the rehistogram modeler; and behavior event frequency fetcher 8050 fetches behavior event frequency 8060 corresponding to the behavior identifier from behavior event histogram 3140, likewise inputting it to the rehistogram modeler. The behavior entity frequency gives the total population of the behavior entity event rehistogram—that is, the total number of entities of the type in question for which the behavior specified by behavior identity 2100 was observed, across all behavior entity event frequencies. The behavior event frequency gives the total population of the underlying behavior entity event histogram—that is, the total number of events observed of that behavior, across all entities of that type; this happens to be equal to the weighted sum of the rehistogram—that is, the sum of the products of the observed frequencies of that behavior in entities of that type and the observed frequencies of those frequencies.

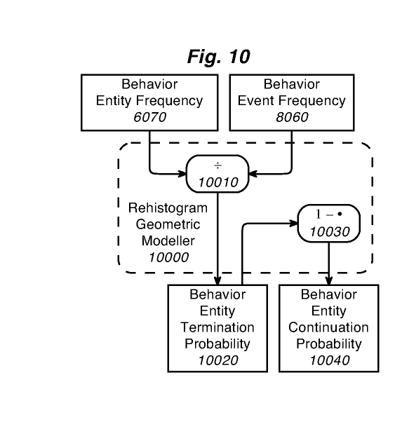

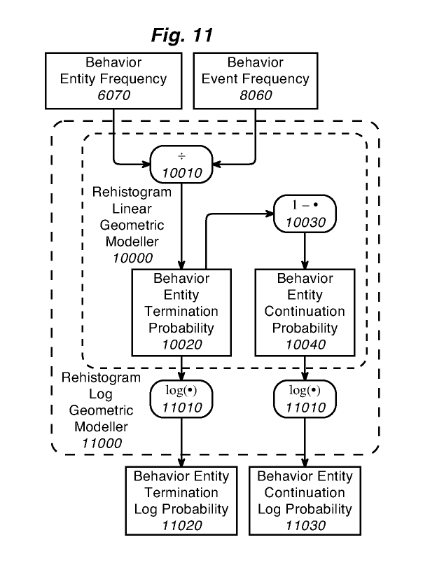

Given an entity event rehistogram 6070, a total entity frequency 6070, and a total event frequency 8060 for a particular behavior 2100, rehistogram modeler 9020 analyzes the rehistogram and computes a model of it, outputting the result as behavior entity event rehistogram model 9030. Exemplary rehistogram modelers for the simple case of geometric distributions are detailed under FIG. 10 and FIG. 11.

Finally, behavior entity event rehistogram model storer 9040 stores the behavior entity event rehistogram model 9030 corresponding to each behavior identifier 2100 in behavior×entity event rehistogram models 1090 for use by anomaly computer 1100 (See FIG. 1).

Information-flow diagram FIG. 10 illustrates a rehistogram modeler 10000 for use in behavior×entity event rehistogram modeler 9000 (See FIG. 9) for behaviors and entities whose event frequencies are expected to follow a geometric distribution, where the entities are either sessions, corresponding to behavior session event rehistograms 3040; subjects, corresponding to behavior subject event rehistograms 3100; or any other rehistogram needed for the specific application. The rehistogram geometric modeler models the probabilities of continuing 10020 versus terminating 10040 repetition of a behavior by an entity of the given type, based on the common ratio of the most likely underlying geometric distribution.

In detail, frequency divider 10010 divides input behavior entity frequency 6070 by behavior event frequency 8060, outputting the result as behavior entity termination probability estimate 10020, which is equal to the reciprocal of the sample mean of the rehistogram. Probability complementer 10030 then takes the complement of the behavior entity termination probability estimate, outputting the result as behavior entity continuation probability estimate 10040, which is equal to the common ratio between the frequencies of successive frequencies in the geometric distribution presumed to underlie the rehistogram.

The input behavior event frequency is the total number of observed events instantiating the behavior in question, across all entities of the type in question, while the input behavior entity frequency is the total number of entities of that type observed to instantiate that behavior.

In an embodiment, the probabilities are represented as high-precision fractions, such as by fixed-point unsigned binary fractions or by IEEE double-precision floating-point numbers. Note that the termination probability and continuation probability are both nonnegative fractions in the range [0 . . . 1].

Information-flow diagram FIG. 11 illustrates an alternative rehistogram modeler for use in behavior×entity event rehistogram modeler 9000 for behaviors and entities whose event frequencies following a geometric distribution. Rehistogram logarithmic geometric modeler 11000 incorporates rehistogram linear geometric modeler 10000, but outputs log probabilities instead of linear probabilities to facilitate combination and scoring of multiple anomalous behaviors per entity, as explained later.

In detail, one instance of logarithm operator 11010 calculates the logarithm of the behavior entity termination probability 10020 from rehistogram linear geometric modeler 10000, outputting the result as behavior entity termination log probability 11020; while another instance of the logarithm operator calculates the logarithm of behavior entity continuation probability 10040 from the rehistogram linear geometric modeler, outputting the result as behavior entity continuation log probability 11030. The logarithms are taken to a base greater than 1, such as 2, e, or 10, depending on whether the results are preferably interpreted in terms of bits, nits, or Hartleys, and in an embodiment are represented in high-precision floating-point, such as IEEE double-precision floating-point numbers.

When the behavior×session event rehistogram 3040 and behavior×subject rehistogram 3080 (See FIG. 3) are used only for automatic anomaly detection using a geometric-distribution model, then rather than store the entire rehistogram, even as a sparse array, it is more efficient to just compute the parameters required for the geometric-distribution models: the entity count for each behavior and the total frequency for each behavior. The behavior entity counts for sessions are already accumulated and stored in behavior session histogram 3020, while those for subjects are already accumulated and stored in behavior subject histogram 3120, and the total behavior frequencies are already accumulated and stored in behavior event histogram 3140.

Accordingly, high-level information-flow diagram FIG. 12 illustrates a batch implicit recursive histograph 12000 for use in the anomalous-behavior detection system 1000 (See FIG. 1). As in the batch explicit recursive histograph 3000 described under FIG. 3, the batch implicit recursive histograph first bins the input event records 1050 into a behavior×session event histogram 3020, but it marginalizes the behavior×session event histogram directly to the behavior session histogram 3060, rather than through the intermediate behavior×session event rehistogram 3040; and likewise marginalizes the behavior×subject event histogram 3080 directly to the behavior subject histogram 3120, rather than through the intermediate behavior×subject event rehistogram 3100.

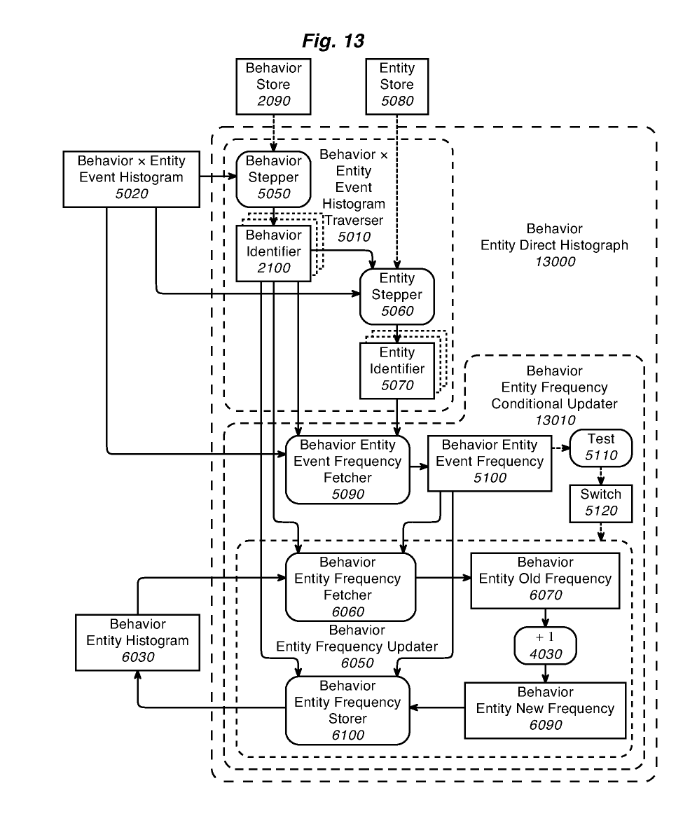

Specifically, when behavior×session event histogram 3040 has been completed, behavior session direct histographs 12010 accumulate one-dimensional marginal behavior session histogram 3060, whose set of bins is the set of observed behaviors, by, for each behavior, tallying the number of sessions with a nonzero value in the bin corresponding to that behavior and that session in the behavior×session event histogram, where the behavior is identified by behavior identifier 2100, and the session is identified by session identifier 2140. Behavior session direct histograph 12010 is described in further detail under FIG. 13.

Similarly, once behavior×subject event histogram 3080 has been completed, behavior subject direct histographs 12020 accumulate one-dimensional marginal behavior subject histogram 3080, whose set of bins is the set of observed behaviors, by, for each behavior, tallying the number of subjects with a nonzero value in the bin corresponding to that behavior and that subject in the behavior×subject event histogram, where the behavior is identified by behavior identifier 2100, and the subject is identified by subject identifier 2070. Behavior subject direct histograph 12020 is described in further detail under FIG. 13.

Information-flow diagram FIG. 13 illustrates a batch behavior entity direct histograph 13000 for use in behavior recursive histograph 3000 (See FIG. 3), where the entities are either sessions, corresponding to behavior session histograph 3050; subjects, corresponding to behavior subject histograph 3110; or any other entity type required for the specific application. Behavior×entity event histogram traverser 5010 steps through the bins in behavior×entity event histogram 5020, which is either behavior×session event histogram 3020, or behavior×subjection event histogram 3080, respectively. For each bin having a nonzero frequency, behavior entity frequency conditional updater 13010 adds the frequency in that bin to the corresponding bin in behavior entity histogram 6030, which is either behavior session histogram 3060 or behavior subject histogram 3120, respectively.

More precisely, in behavior×entity event rehistogram traverser 5010, behavior stepper 5050 steps through the set of behaviors in behavior×entity event histogram 5020, and outputs each one as a behavior identifier 2100. For each behavior, event frequency stepper 6040 steps through the set of entities for that behavior in the behavior×entity event histogram, and outputs each one as an entity identifier 5070. In an embodiment, as illustrated here, the behavior stepper precedes the entity stepper, in accordance with the preferred behavior-major orientation of the behavior×entity histograms. For a behavior-minor histogram, an embodiment traverses the rehistogram by event frequency first instead.

In embodiments where behavior×entity event histogram 5020 does not directly provide the set of actually observed behaviors, in an embodiment behavior stepper 5050 only steps through the actually observed behaviors as obtained from behavior store 2090, instead of stepping through all possible behaviors. Likewise, in an embodiment, if the histogram does not directly provide the set of actually observed entities for the respective type of entity, then entity stepper 5070 only steps through the actually observed entities as obtained from entity store 5080.

In behavior entity frequency conditional updater 13010, behavior entity event frequency fetcher 5090 fetches the behavior entity event frequency 5100 corresponding to behavior identifier 2100 and entity 5070 from behavior×entity event histogram 5020 and inputs it to behavior entity frequency updater 6050.

In embodiments where behavior×entity event histogram 5020 does not directly provide the set of actually observed combinations of behavior identifier 2100 and event identifier 5070, for example if a complete array of the product of all behaviors and all entities of that type is used to represent the histogram, in an embodiment frequency test 5110 checks each behavior entity event frequency 5100, setting switch 5120 so that behavior entity frequency updater 6050 is executed only if the behavior entity event frequency is positive, so as to avoid unnecessary computation.

For each input combination of behavior identifier 2100 and behavior entity event frequency 5100, behavior entity frequency updater 6050 increments by one the frequency in the bin corresponding to that behavior identifier in behavior entity histogram 6030. More precisely, behavior entity frequency fetcher 6060 fetches, from the behavior entity histogram, the behavior entity frequency 6070 of the input behavior identifier, denoting the frequency of that behavior among all entities of that type observed so far. Frequency incrementer 4030 increases the behavior entity frequency by one (1) to denote one additional entity of that type exhibiting that behavior, and outputs the result as increased behavior entity frequency 6090. Behavior entity frequency storer 6100 stores the updated behavior entity frequency in the bin corresponding to that behavior in the behavior entity histogram. In embodiments using a sparse representation of the behavior entity histogram, if that bin does not already exist in the behavior entity histogram, it is first created and inserted therein.

In many applications, it is important to be able to detect anomalous behavior in real time in order to remediate the behavior in a timely manner. In such cases, instead of creating recursive behavior histogram 1070 from an entire batch of observations from scratch, it is more efficient to update the histograms adaptively, on the fly, as each observation comes in, with a sliding window.

Accordingly, information-flow diagram FIG. 14 illustrates an adaptive explicit recursive histograph 14000 for use in the anomalous-behavior detection system 1000 (See FIG. 1). The adaptive histograph concurrently bins each input event record 1050 into each of the component histograms as it is received, and de-bins it again as it expires at the end of the sliding window: behavior×session event recursive histogram updater 14010 adaptively updates behavior×session event histogram 3020, behavior session histogram 3060, and behavior×session event rehistogram 3040; while behavior×subject event recursive histogram updater 14020 adaptively updates behavior×subject event histogram 3080, behavior subject histogram 3120, and behavior×subject event rehistogram 3100; and behavior event histogram updater 14030 adaptively updates behavior event histogram 3140.

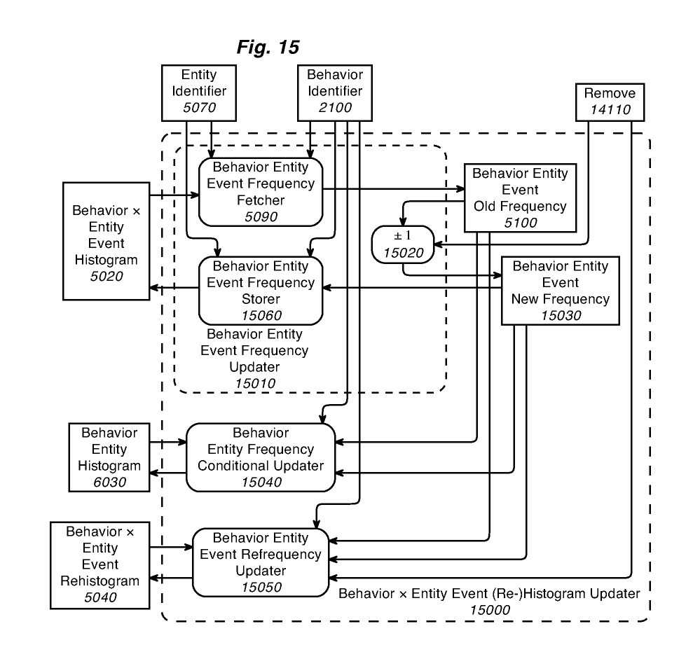

In greater detail, in behavior×session event recursive histogram updater 14010, behavior session event frequency updater 14040 fetches, from behavior×session event histogram 3020, behavior session old frequency 4020 corresponding to behavior identifier 2100 and session identifier 2140 in input event record 1050, increments or decrements the frequency according to remove switch 14110, and stores the updated behavior session event frequency back in the behavior×session event histogram. Whenever the behavior session event frequency is incremented from zero to one or is decremented from one to zero, then behavior session event frequency updater 14050 increments or decrements the corresponding bin in behavior session histogram 3060, respectively. Behavior session event refrequency updater 14060 decrements or increments the bin in behavior×session event rehistogram 3040 corresponding to the old behavior session event frequency and increments or decrements the bin corresponding to the new behavior session event frequency in accordance with the remove switch. Behavior×session event recursive histogram updater 14010 is described further in connection with FIG. 15 through FIG. 17.

Similarly, in behavior×subject event recursive histogram updater 14020, behavior subject event frequency updater 14070 fetches, from behavior×subject event histogram 3080, behavior subject old frequency 7070 corresponding to behavior identifier 2100 and subject identifier 2070 in input event record 1050, increments or decrements to the frequency in accordance with remove switch 14110, and stores the updated behavior subject event frequency back in the behavior×subject event histogram. Whenever the behavior subject event frequency is incremented from zero to one or decremented from one to zero, then behavior subject event frequency updater 14080 increments or decrements the corresponding bin in behavior subject histogram 3120, respectively. Behavior subject event refrequency updater 14090 decrements or increments the bin in behavior×subject event rehistogram 3100 corresponding to the old behavior subject event frequency and increments or decrements the bin corresponding to the new behavior subject event frequency in accordance with the remove switch. Behavior×subject event recursive histogram updater 14010 is described further in connection with FIG. 15 through FIG. 17.

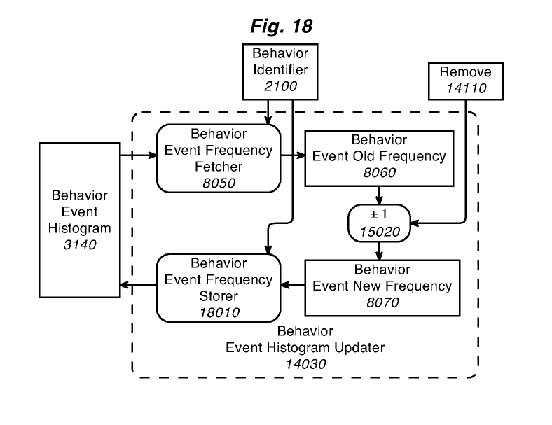

In behavior event histogram updater 14030, behavior event frequency updater 14100 fetches behavior event frequency 8060 corresponding to behavior identifier 2100 from behavior event histogram 3140, increments or decrements the behavior event frequency in accordance with remove switch 14110, and stores the updated frequency in the behavior event histogram. Behavior event histogram updater 14030 is described further under FIG. 18.

In the preferred embodiment, as shown here, to minimize execution time, the behavior session event recursive histogram updater 14010, behavior subject event recursive histogram updater 14020, and behavior event histogram updater 14030 all operate concurrently. Likewise, within the behavior session event recursive histogram updater, the behavior session event frequency updater 14040, behavior session frequency updater 14050, and behavior session event refrequency updater 14060 operate concurrently to the extent possible; and within the behavior subject event recursive histogram updater, the behavior subject event frequency updater 14070, behavior subject frequency updater 14080, and behavior subject event refrequency updater 14090 operate concurrently to the extent possible. In an alternative embodiment, for example when implemented on a single sequential processor, the various component updaters and their several subcomponents operate in sequence, where the order of execution is not necessarily as shown from top to bottom here, but is constrained only on the inherent interdependencies of the steps, such as the dependence of the behavior session frequency updater and the behavior session event refrequency updater on the output of the behavior session event frequency updater.

In implementations representing any of the component adaptive histograms 1070 as a sparse array, whenever a frequency for a bin reaches a value of one (1), if that bin does not yet exist in the histogram, then the histogram updater creates and inserts the bin before storing the value in it. Moreover, whenever a frequency becomes zero (0), the histogram updater deletes the bin from the histogram instead of storing zero in it, in order to conserve memory and speed computation.

Information-flow diagram FIG. 15 illustrates an adaptive explicit behavior×entity event recursive histograph 15000 for use in adaptive explicit recursive histograph 14000 (See FIG. 14), where the entities are either sessions, corresponding to adaptive behavior×session event recursive histograph 14010, subjects, corresponding to adaptive behavior×subject event recursive histograph 14020, or any other type of entity needed for the particular application. Behavior entity event frequency updater 15010 fetches the behavior entity event old frequency 5100 from behavior entity event histogram 5020, increments or decrements 15020 the frequency according to remove switch 14110, and stores the updated behavior entity event frequency 15030 back in the behavior×entity event histogram. The old and new behavior entity frequencies are passed along to behavior entity frequency conditional updater 15040 and behavior entity event refrequency updater 15050.

More specifically, in behavior entity event frequency updater 15010, behavior entity event frequency fetcher 5090 fetches the event frequency corresponding to input behavior identifier 2100 and entity identifier 5070 from behavior×entity event histogram 5020, outputting the result as behavior entity event old frequency 5100. Nudger 15020 either increments or decrements the behavior entity event frequency depending on whether remove switch 14110 is off or on, respectively, and outputs the result as behavior entity event new frequency 15030. Finally, behavior entity event frequency storer 15060 stores the new frequency back in the bin corresponding to the input behavior identifier and entity identifier in the behavior×entity event histogram.

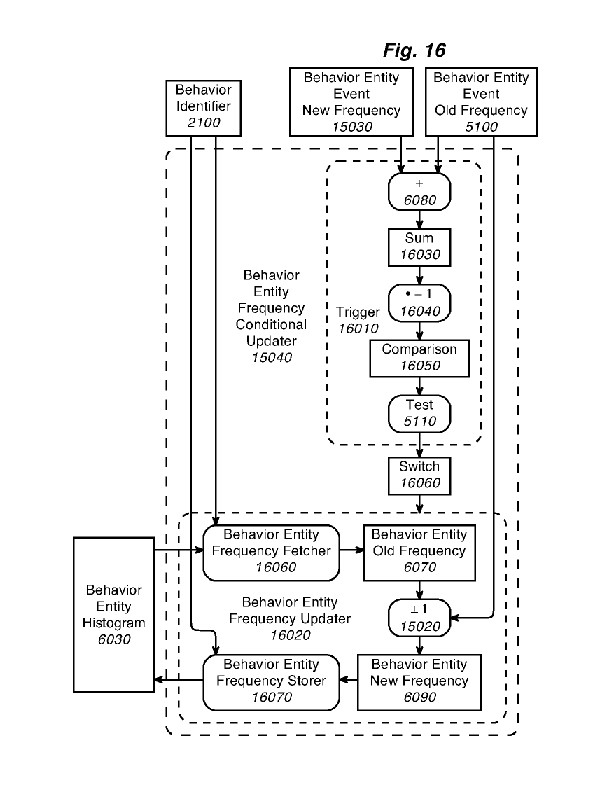

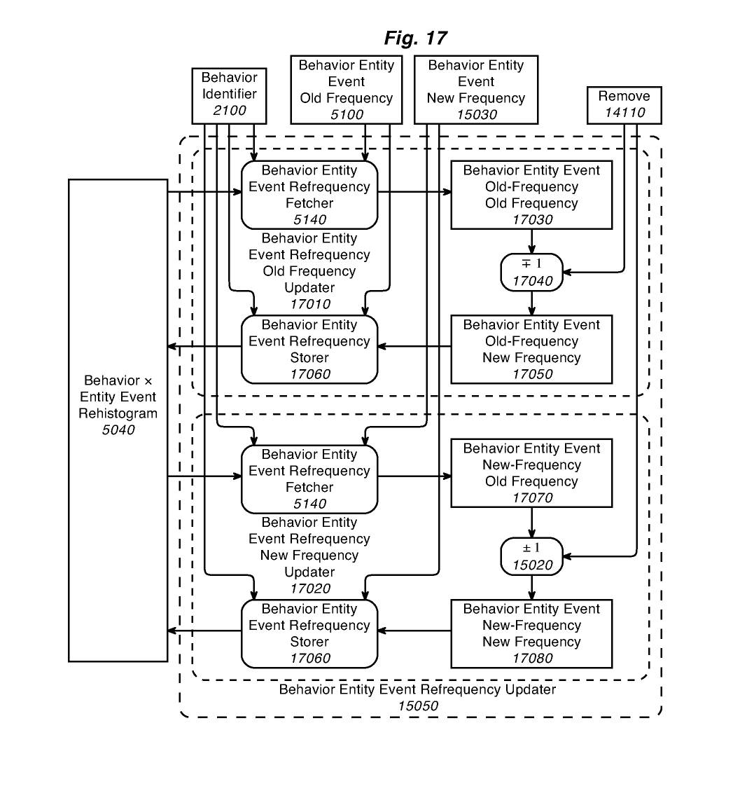

The input behavior identifier, behavior entity event old frequency, and behavior entity event new frequency are all passed on both to the behavior entity frequency conditional updater 15040, which updates behavior entity histogram 6030, as discussed in greater detail under FIG. 16; and to the behavior entity event refrequency updater 15050, which updates behavior×entity event rehistogram 5040, as discussed under FIG. 17.

Information-flow diagram FIG. 16 illustrates a behavior entity frequency conditional updater 15040 for use in adaptive explicit behavior×entity recursive histograph 15000 (See FIG. 15), where the entities may be either sessions, corresponding to behavior session frequency updater 14050 (See FIG. 14); or behavior subject frequency updater 14080, or any other entity the specific application requires. Trigger 16010 examines input behavior entity event new frequency 15030 and behavior entity event old frequency 5100 to determine whether to switch 16060 behavior entity frequency updater 16020 on or off. When switched on, the behavior entity frequency updater increments or decrements the bin corresponding to input behavior identifier 2100 in accordance with the value of the behavior entity event old frequency.

In detail, in trigger 16010, frequency adder 6080 adds input behavior entity event new frequency 15030 and behavior entity event old frequency 5100, outputting the result as sum 16030. Frequency decrementer 16040 subtracts one (1) from the sum, outputting the decremented value as comparison 16050. Frequency test 5110 checks the resulting comparison, setting switch 16060 accordingly to execute behavior entity frequency updater 16020 if and only if the comparison is zero, which occurs if and only if either this is the first observation of this behavior being added to the behavior×entity event histogram 5020 (See FIG. 5) for this entity, in which case behavior entity event old frequency is zero (0) and behavior entity event new frequency is one (1); or this is the last observation of this behavior being removed from the behavior×entity event histogram for this entity. Note that the decrementer can always safely subtract one from the sum of the old and new frequencies without danger of underflow, because the old and new frequencies are always nonnegative, and because they always differ by one, they cannot both be zero, so their sum can never be zero.

In behavior entity frequency updater 16020, behavior entity frequency fetcher 6060 fetches the behavior entity frequency 6070 corresponding to input behavior identifier 2100 from behavior entity histogram 6030. Nudger 15020 either increments or decrements the behavior entity frequency, depending on whether the old behavior entity event frequency is respectively zero (0)—implying that the new event frequency is one, and indicating that the first observation of this behavior for this entity has just entered the sliding window; or one (1)—implying that the new event frequency is zero, and indicating that the last observation of this behavior for this entity has just left the sliding window. Finally, behavior entity frequency storer 16070 stores the new behavior entity frequency 6090 back in the bin corresponding to the input behavior identifier in the behavior entity histogram.

In applications for which optimizing computation is more important than optimizing execution time, a switch 16060 may switch on or off the entire behavior entity frequency updater 16020, as shown here. But in applications for which processing speed is more important, behavior entity frequency fetcher 6060 fetches behavior entity old frequency 6070 concurrently as trigger 16010 determines whether to update the behavior entity frequency, so that the switch only controls nudger 15020 and behavior entity frequency storer 16070, and the behavior event frequency updater does not need to wait for the trigger determination before beginning operation, in case the trigger's determination is positive.

Information-flow diagram FIG. 17 illustrates a behavior×entity event refrequency updater 15050 for use in adaptive explicit behavior×entity recursive histograph 15000 (See FIG. 15), where the entities may be either sessions, corresponding to behavior session event refrequency updater 14060 (See FIG. 14); or behavior subject event refrequency updater 14090, or any other entity the specific application requires. Behavior entity event refrequency old-frequency updater 17010 decrements or increments the bin in behavior×entity event rehistogram 5040 corresponding to input behavior identifier 2100 and old behavior entity event frequency 5100; while behavior entity event refrequency new-frequency updater 17020 increments or decrements the bin corresponding to the behavior identifier and new behavior session event frequency 15030 in the histogram, both in accordance with remove switch 14110.

More specifically, in behavior entity event refrequency old-frequency updater 17010, behavior entity event refrequency fetcher 5140 fetches the event frequency frequency corresponding to input behavior identifier 2100 and input behavior entity event old frequency 5100 from behavior×entity event rehistogram 5040, outputting the result as behavior entity event old-frequency old frequency 17030. Nudger 17040 either decrements or increments the behavior entity event frequency frequency, depending on whether remove switch 14110 is off or on, respectively, and outputs the result as behavior entity event old-frequency new frequency 17050. Finally, behavior entity event refrequency storer 17060 stores the updated behavior entity event frequency frequency back in the bin corresponding to the input behavior identifier and behavior entity event old frequency in the behavior×entity event rehistogram.

Similarly, in behavior entity event refrequency new-frequency updater 17020, behavior entity event refrequency fetcher 5140 fetches the event frequency frequency corresponding to input behavior identifier 2100 and input behavior entity event new frequency 15030 from behavior×entity event rehistogram 5040, outputting the result as behavior entity event new-frequency old frequency 17070. Nudger 15020 either increments or decrements the behavior entity event frequency frequency, depending on whether remove switch 14110 is off or on, respectively, and outputs the result as behavior entity event new-frequency new frequency 17080. Finally, another instance of behavior entity event refrequency storer 17060 stores the updated behavior entity event frequency frequency back in the bin corresponding to the input behavior identifier and behavior entity event new frequency in the behavior×entity event rehistogram.

Information-flow diagram FIG. 18 illustrates a behavior event histogram updater 14030 for use in adaptive behavior recursive histograph 14000 (See FIG. 14). The behavior event histogram updater increments or decrements the bin in behavior event histogram 3140 corresponding to input behavior identifier 2100 in accordance with remove switch 14110.

More precisely, behavior event frequency fetcher 8050 fetches the event frequency corresponding to input behavior identifier 2100 from behavior entity histogram 3140, outputting the result as behavior event old frequency 8060. Nudger 15020 either increments or decrements the behavior event frequency, depending on whether remove switch 14110 is off or on, respectively, and outputs the result as behavior event new frequency 8050. Finally, behavior event frequency storer 18010 stores the updated behavior event frequency back in the bin corresponding to the input behavior identifier in the behavior event histogram.

Information-flow diagram FIG. 19 illustrates an adaptive implicit recursive histograph 19000 for use in the anomalous-behavior detection system 1000 (See FIG. 1) as an alternative to adaptive recursive histograph 14000 applications where the behavior×session event rehistogram 3040 and behavior×subject rehistogram 3080 (See FIG. 3) are used only for automatic anomaly detection using a geometric-distribution model, in which case, rather than maintaining the entire rehistograms, it is more efficient to simply track the parameters required for the geometric-distribution models: the entity count for each behavior, which is already maintained in behavior session histogram 3020 and behavior subject histogram 3120; and the total frequency for each behavior, which is already maintained in behavior event histogram 3140.

Unlike in batch implicit recursive histograph 12000 (See FIG. 12), where omitting the rehistograms entails changing the way that behavior session histogram 3060 and behavior subjection histogram 3120 are computed, in adaptive implicit recursive histograph 19000, there are no dependencies on the rehistograms, so they can simply be omitted without repercussion. Thus, FIG. 19 is identical to FIG. 14 except for the omission of the behavior session event refrequency updater 14060 from behavior×session event direct histogram updater 19010, of behavior subject event refrequency updater 14090 from behavior×subject event direct histogram updater 19020, their input paths, and the corresponding rehistograms.

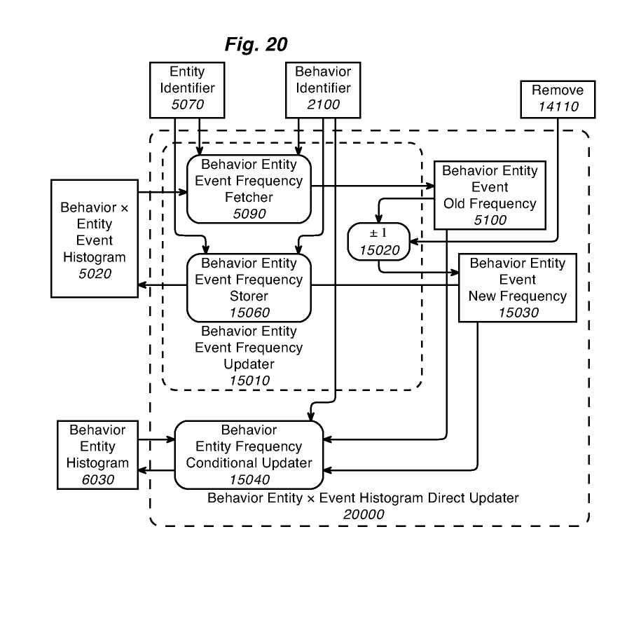

Information-flow diagram FIG. 20 illustrates an adaptive direct behavior×entity event recursive histograph 20000 for use in adaptive implicit recursive histograph 19000 (See FIG. 19) as an alternative to adaptive explicit behavior×entity event histograph 15000 (See FIG. 15), where the entities are either sessions, corresponding to adaptive behavior×session event recursive histograph 19010, subjects, corresponding to adaptive behavior×subject event recursive histograph 19020, or any other type of entity needed for the particular application. Again, because of the absence of dependencies on the behavior×entity event rehistogram 5040 in the adaptive behavior×entity event recursive histograph 15000, it can be cleanly omitted without affecting the other components of the adaptive direct behavior×entity event recursive histograph, so FIG. 20 is identical to FIG. 15 but for the omission of the rehistograph, its input paths, and the rehistogram.

Information-flow diagram FIG. 21 illustrates a behavior×entity event frequency anomaly computer 21000 for use in anomalous behavior detection system 1000 (See FIG. 1), where the entities are either sessions, corresponding to a behavior×session event frequency anomaly computer; subjects, corresponding to a behavior×subject frequency anomaly computer; or any additional entity type required for the specific application. Behavior×entity event histogram traverser 5010 steps through the bins in behavior×entity event histogram 5020, which is either behavior×session event histogram 3020, or behavior×subject event histogram 3080, respectively. For each bin with a nonzero frequency, behavior entity event frequency anomaly conditional estimator 21010 estimates the anomaly of the frequency of that behavior for that entity.

In detail, in behavior×entity event histogram traverser 5010, behavior stepper 5050 steps through the set of behaviors in behavior×entity event histogram 5020, outputting each one as a behavior identifier 2100. For each behavior, entity stepper 5060 steps through the set of entities for that behavior in the behavior×entity event histogram, outputting each one as an entity identifier 5070, which is either a session identifier 2140 or a subject identifier 2070 (See FIG. 2), respectively. In the preferred embodiment, the behavior traversal precedes the entity traversal, as illustrated here, corresponding to the preferred behavior-major access priority of the behavior×entity event histogram. For a behavior-minor histogram, the preferred embodiment traverses the histogram by entity first instead.

In embodiments wherein behavior×entity event histogram 5020 itself does not immediately provide the set of actually observed behaviors, in an embodiment behavior stepper 5050 steps through only the actually observed behaviors as given by behavior store 2090, rather than through all possible behaviors. Likewise, if the histogram itself does not immediately provide the set of actually observed entities of a given entity type, then in an embodiment entity stepper 5060 steps through only the actually observed entities as given by entity store 5080, which is either session store 2120 or subject store 2060, respectively.

In behavior entity event frequency anomaly conditional estimator 21010, behavior entity event frequency fetcher 5090 fetches the behavior entity event frequency 5100 corresponding to behavior identifier 2100 and entity identifier 5070 from behavior×entity event histogram 5020 and outputs it to rehistogram frequency anomaly estimator 21050 in behavior entity event frequency anomaly estimator 21020.

In embodiments wherein the behavior×entity event histogram 5020 itself does not immediately provide the set of actually observed combinations of behavior identifier 2100 and entity identifier 5070, frequency test 5110 checks each behavior entity event frequency 5100, setting switch 5120 accordingly to execute behavior entity event frequency anomaly estimator 21020 if and only if the behavior entity event frequency is positive.

In behavior entity event frequency anomaly estimator 21020, behavior entity event rehistogram model fetcher 21030 fetches the behavior entity event rehistogram model 21040 corresponding to behavior identifier 2100 from behavior×entity event rehistogram models 1090 and outputs it to rehistogram frequency anomaly estimator 21050; while behavior event frequency fetcher 8050 fetches the behavior event frequency 8060 corresponding to the input behavior identifier from behavior event histogram 3140 and likewise outputs it to the rehistogram frequency anomaly estimator.

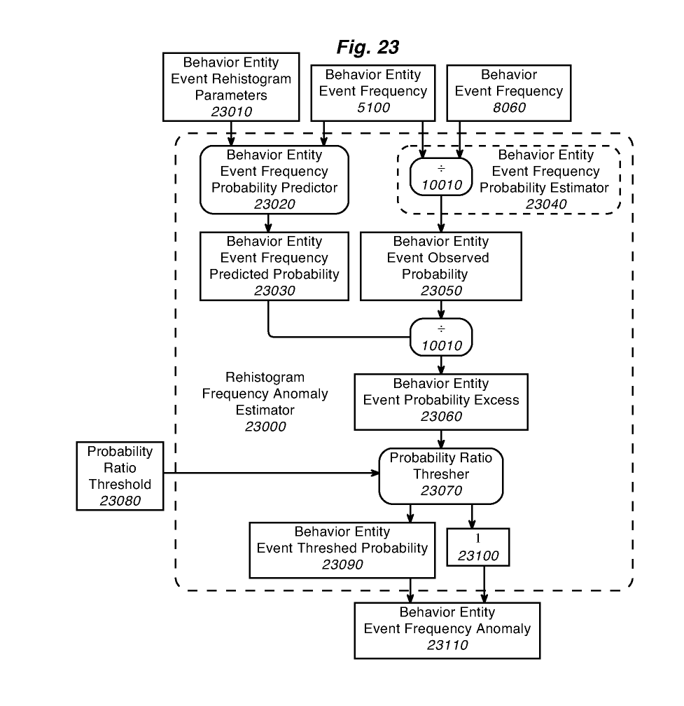

Rehistogram frequency anomaly estimator 21050 estimates the behavior entity event frequency anomaly 21060 from the behavior entity event frequency 5100 corresponding to the behavior identifier 2100 and entity identifier 5070, along with the behavior entity event rehistogram model 21040 and behavior event frequency 8060 corresponding to the behavior identifier. The rehistogram frequency anomaly estimator is described in greater detail in FIG. 23 through FIG. 28.

Finally, behavior entity event frequency anomaly storer 21070 updates or stores the anomaly 21060 corresponding to each observed combination of behavior identifier 2100 and entity identifier 5070 in behavior×entity event frequency anomalies 21080 for use by anomaly evaluator 1120 (See FIG. 1), as discussed further in connection with FIG. 29.

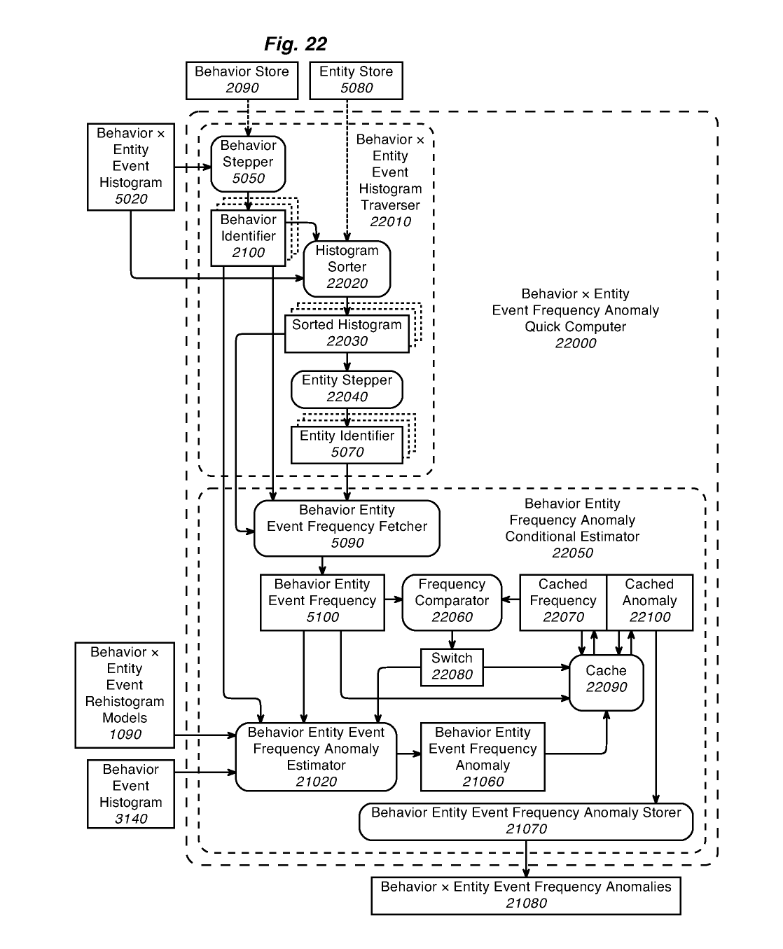

Information-flow diagram FIG. 22 illustrates an alternative behavior×entity event frequency anomaly quick computer 22000 for use in anomalous behavior detection system 1000 (See FIG. 1) in place of behavior×entity event frequency anomaly computer 21000 in applications where minimizing execution time is more important than minimizing complexity. The entities are either sessions, corresponding to a behavior×session event frequency anomaly computer; subjects, corresponding to a behavior×subject frequency anomaly computer; or any additional entity type required for the specific application. Modified behavior×entity event histogram traverser 22010 steps through the bins in behavior×entity event histogram 5020, which is either behavior×session event histogram 3020, or behavior×subject event histogram 3080, respectively, in a frequency-sorted order to enable more-efficient computation in behavior entity event frequency anomaly conditional estimator 22050, which computes the anomaly only once for each frequency for each behavior. For each bin with a nonzero frequency, the behavior entity event frequency anomaly conditional estimator estimates the anomaly of the frequency of that behavior for that entity.

More specifically, in modified behavior×entity event histogram traverser 22010, behavior stepper 5050 steps through the set of behaviors in behavior×entity event histogram 5020, which is either behavior×session event histogram 3020, or behavior×subject event histogram 3080, respectively, outputting each one as a behavior identifier 2100. For each behavior, histogram sorter 22020 sorts the behavior entity event histogram for that behavior in order of decreasing event frequency, outputting the result as sorted histogram 22030. Entity stepper 22040 steps through the frequency-sorted entities in the sorted histogram, outputting each as entity identifier 5070, which is either a session identifier 2140 or a subject identifier 2070 (See FIG. 2), respectively. Because the bins are traversed in order of decreasing frequency, the entity stepper stops as soon as it encounters a bin with a frequency of zero, so there is no need for a frequency test inside the consumer of the behavior identifiers and entity identifiers.

In embodiments wherein behavior×entity event histogram 5020 itself does not immediately provide the set of actually observed behaviors, in an embodiment behavior stepper 5050 steps through only the actually observed behaviors as given by behavior store 2090, rather than through all possible behaviors. Likewise, if the histogram itself does not immediately provide the set of actually observed entities of a given entity type, then in an embodiment entity stepper 22040 steps through only the actually observed entities as given by entity store 5080, which is either session store 2120 or subject store 2060, respectively.

In behavior entity frequency anomaly conditional estimator 22050, behavior entity event frequency fetcher 5090 fetches behavior entity event frequency 5100 corresponding to behavior identifier 2100 and entity identifier 5070 from behavior×entity event histogram 5020. Frequency comparator 22060 then compares this frequency with cached frequency 22070, outputting switch 22080 to switch between cache 22090 and behavior entity event frequency anomaly estimator 21020 depending on whether the fetched value is equal to the cached value or not, respectively.

If the fetched behavior entity event frequency 5100 is equal to the cached frequency 22070, then cache 22090 simply outputs the cached anomaly 22100 associated with the cached frequency to behavior entity event frequency anomaly storer 21070. Otherwise, behavior entity event frequency anomaly estimator 21020 first estimates the behavior entity event frequency anomaly 21060 for the new fetched frequency and the corresponding behavior identifier 2100 from behavior×entity event rehistogram models 1090 and behavior event histogram 3140; after which the cache updates the cached frequency frequency and cached anomaly with the new behavior entity event frequency and the new behavior entity event frequency anomaly, respectively.

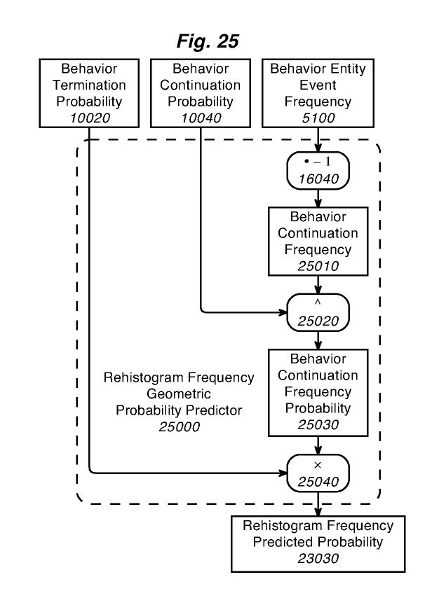

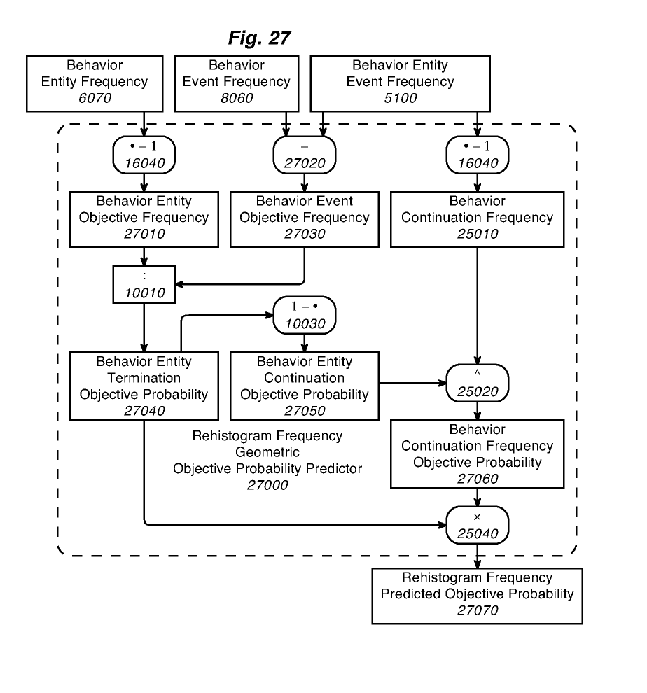

Information-flow diagram FIG. 23 illustrates a rehistogram frequency anomaly estimator 23000 for use in behavior×entity event frequency anomaly computer 21000 (See FIG. 21) or 22000 (See FIG. 22) in conjunction with a linear rehistogram modeler such as that in FIG. 10 and a linear rehistogram behavior entity event frequency probability predictor such as that in FIG. 25 or FIG. 27. The rehistogram frequency anomaly estimator compares the predicted probability 23030 of an observed behavior entity event frequency 5100 based on a model 23010 of the rehistogram, with the estimated probability 23050 of the observed behavior entity event frequency based on the total frequency 8060 of that behavior.

In more detail, behavior entity event frequency probability predictor 23020 predicts the probability of the input observed behavior entity event frequency 5100 from the input behavior entity event rehistogram parameters 23010, which are either a rehistogram model 1090 (See FIG. 9) for biased predictors such as that in FIG. 25, or the statistics on which the model is based for objective predictors such as that in FIG. 27, and outputs the result as behavior entity event frequency predicted probability 23030.

In behavior entity event frequency probability estimator 23040, frequency divider 10010 divides the input behavior entity event frequency 5100 by the input behavior event frequency 8060 to yield behavior entity event frequency observed probability 23050. Another instance of frequency divider 10010 then divides behavior entity event frequency predicted probability 23030 by the behavior event frequency observed probability, outputting the result as behavior entity event probability excess ratio 23060.

Probability-ratio thresher 23070 compares the behavior entity event probability excess 23060 to an application-specific probability-ratio threshold 23080, passing through the behavior entity event threshed probability 23090 as the behavior entity event frequency anomaly 23110 if it exceeds the threshold, and otherwise outputting an anomaly of one (1) 23100 as the anomaly, denoting complete absence of anomaly. In one embodiment, the probability ratio threshold is one, so that only those of an entity's behaviors having higher-than-predicted frequency are considered anomalous and counted towards the total anomaly score 1140 (See FIG. 1) for that entity. A threshold higher than 1 decreases false positives at the expense of increasing false negatives; while a threshold lower than 1 decreases false negatives at the expense of increasing false positives.

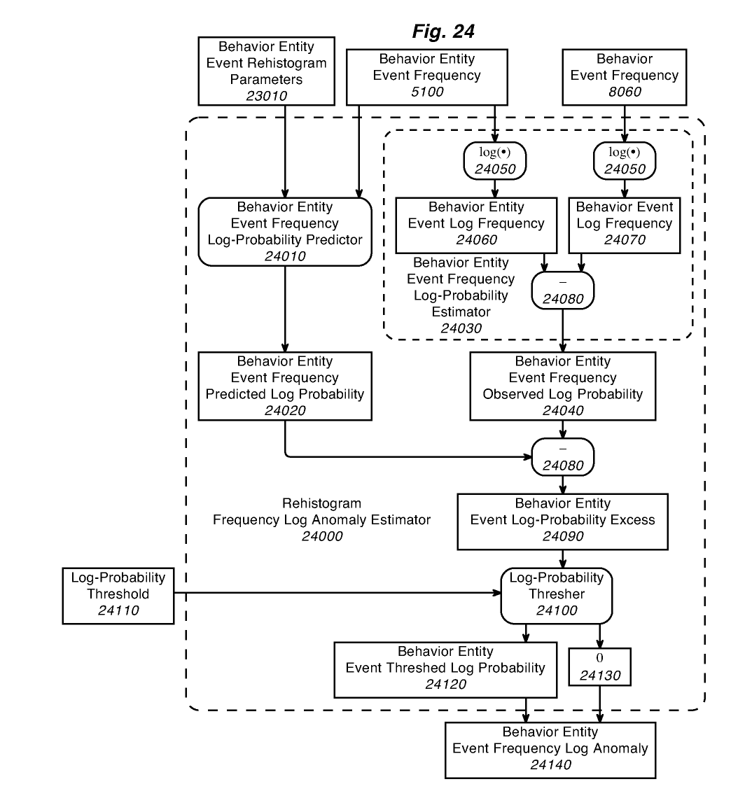

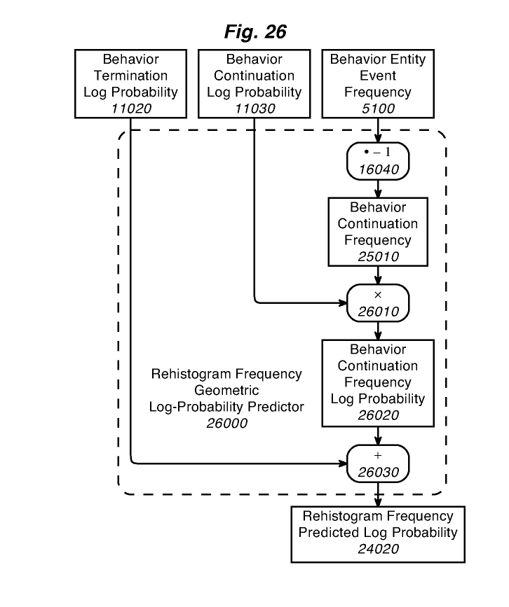

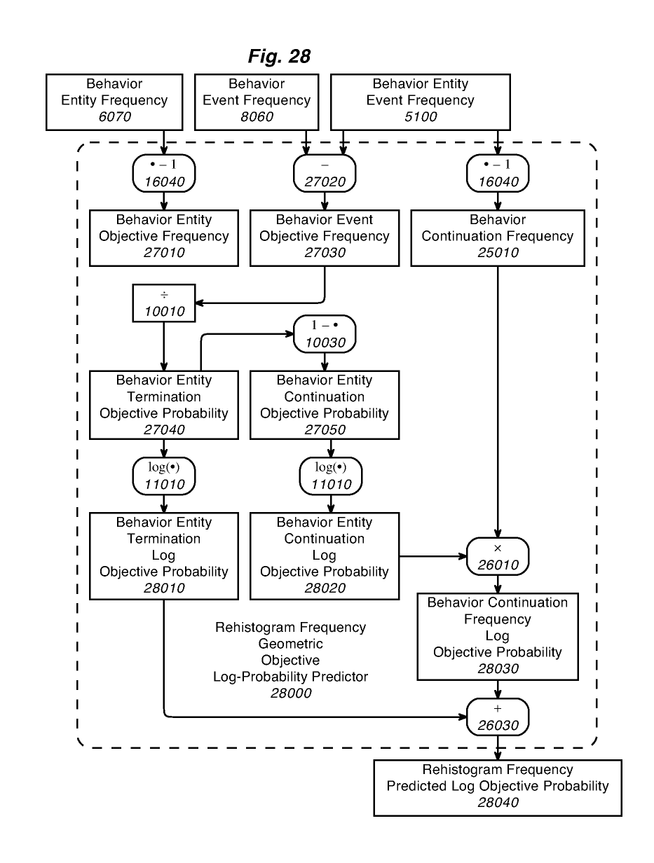

Information-flow diagram FIG. 24 illustrates a rehistogram frequency log anomaly estimator 24000 for use in behavior×entity event frequency anomaly computer 21000 (See FIG. 21) or 22000 (See FIG. 22) in conjunction with a logarithmic rehistogram modeler such as that in FIG. 11 and a logarithmic rehistogram behavior entity event frequency probability predictor such as that in FIG. 26 or FIG. 28. The rehistogram frequency anomaly estimator compares the predicted log probability 24020 of an observed behavior entity event frequency 5100 based on a model 23010 of the rehistogram, with the estimated probability 24040 of the observed behavior entity event frequency based on the total frequency 8060 of that behavior.

In more detail, behavior entity event frequency log-probability predictor 24010 predicts the log-probability of the input observed behavior entity event frequency 5100 from the input behavior entity event rehistogram parameters 23010, which are either a rehistogram model 1090 (See FIG. 9) for biased predictors such as that in FIG. 26, or the statistics on which the model is based for objective predictors such as that in FIG. 28, and outputs the result as behavior entity event frequency predicted log probability 24020.

In behavior entity event frequency log-probability estimator 24030, frequency logarithm operator 24050 calculates the logarithm of input behavior entity event frequency 5100, outputting the result as behavior entity event log frequency 24060, while another instance of frequency logarithm operator 24050 calculates the logarithm of input behavior event frequency 8060, outputting the result as behavior event log frequency 24070. Log-frequency subtractor 24080 then subtracts the behavior event log frequency from the behavior entity event log frequency to yield behavior entity event frequency observed log probability 24040. Log probability subtractor 24080 then subtracts the behavior event frequency observed probability from the behavior entity event frequency predicted probability 24020, outputting the result as behavior entity event log-probability excess ratio 24090.

Log-probability thresher 24100 compares the behavior entity event log-probability excess 24090 to an application-specific log-probability threshold 24110, passing through the behavior entity event threshed log probability 24120 as the behavior entity event frequency log anomaly 24140 if it exceeds the threshold, and otherwise outputting zero (0) 24130 as the anomaly, denoting complete absence of anomaly. In an embodiment, the log-probability difference threshold is zero, so that all and only those of an entity's behaviors having higher-than-predicted frequency are considered anomalous and counted towards the total anomaly score 1140 (See FIG. 1) for that entity. A threshold higher than 0 decreases false positives at the expense of increasing false negatives; while a threshold lower than 0 decreases false negatives at the expense of increasing false positives.

Information-flow diagram FIG. 25 illustrates a biased rehistogram frequency geometric probability predictor 25000 for use in rehistogram frequency anomaly estimator 23000 in conjunction with linear rehistogram geometric-distribution rehistogram modeler 10000 (See FIG. 10). Frequency decrementer 16040 subtracts one (1) from input behavior entity event frequency 5100, outputting the result as behavior continuation frequency 25010—denoting the subtraction of the termination event to yield the number of repetition continuations. Probability power operator 25020 raises input behavior continuation probability 10040 to the behavior continuation frequency to yield behavior continuation frequency probability 25030. Probability multiplier 25040 then multiplies the behavior continuation frequency probability by input behavior termination probability 10020 to yield rehistogram frequency predicted probability 23030—the total predicted probability of the observed frequency of the behavior given the rehistogram.

Information-flow diagram FIG. 26 illustrates a biased rehistogram frequency geometric logarithmic probability predictor 26000 for use in rehistogram frequency log-anomaly estimator 24000 in conjunction with logarithmic rehistogram geometric-distribution modeler 11000 (See FIG. 11). Frequency decrementer 16040 subtracts one (1) from input behavior entity event frequency 5100, outputting the result as behavior continuation frequency 25010—denoting the subtraction of the termination event to yield the number of repetition continuations. Log-probability multiplier 26010 multiplies input behavior continuation log probability 11030 by the behavior continuation frequency to yield behavior continuation frequency log probability 26020. Log-probability adder 26030 then adds the behavior continuation frequency log probability to input behavior termination log probability 11020 to yield rehistogram frequency predicted log probability 24020—the total predicted log probability of the observed frequency of the behavior given the rehistogram.

Information-flow diagram FIG. 27 illustrates an objective rehistogram frequency geometric probability predictor 27000 for use in rehistogram frequency anomaly estimator 23000 for behaviors whose event frequencies are expected to follow a geometric distribution across entities. The objective rehistogram frequency geometric probability predictor differs from its biased counterpart 25000 (See FIG. 25) in excluding the entity in question from the statistics used to model the rehistogram. Because the objective probability predictor alters the rehistogram statistics in an entity-specific way, it cannot make use of pre-computed rehistogram models, instead needing to incorporate the modeling process. Thus the biased predictor is preferred in applications where speed is critical, while the objective predictor is preferred in applications where accuracy is more important.

Frequency decrementer 16040 subtracts one (1) from input behavior entity frequency 6070—the total number of observed events instantiating the behavior in question, across all entities of the type in question—to yield behavior entity objective frequency 27010, while frequency subtractor 27020 subtracts observed behavior entity event frequency 5100 from total behavior event frequency 8060 to yield behavior event objective frequency 27030. Frequency decrementer 16040 subtracts one (1) from input behavior entity event frequency 5100, outputting the result as behavior continuation frequency 25010—denoting the subtraction of the termination event to yield the number of repetition continuations—the total number of entities of that type observed to instantiate that behavior.

Frequency divider 10010 divides behavior entity objective frequency 27010 by behavior event objective frequency 27030, outputting the result as behavior entity termination objective probability estimate 27040, which is equal to the reciprocal of the sample mean of the objective rehistogram. Probability complementer 10030 then takes the complement of the behavior entity termination objective probability estimate, outputting the result as behavior entity continuation objective probability estimate 27050, which is equal to the common ratio between the frequencies of successive frequencies in the geometric distribution presumed to underlie the objective rehistogram.

Frequency decrementer 16040 subtracts one (1) from input behavior frequency 5100, outputting the result as behavior continuation frequency 25010—denoting the subtraction of the termination event to yield the number of repetition continuations. Probability power operator 25020 raises behavior entity continuation objective probability 27050 to the behavior continuation frequency to yield behavior continuation frequency objective probability 27060. Finally, probability multiplier 25040 multiplies the behavior continuation frequency objective probability by behavior entity termination objective probability 27040 to yield rehistogram frequency predicted objective probability 27070 the total predicted probability of the observed frequency of the behavior given the objective rehistogram.

Note that the rehistogram distribution for singlets, behaviors exhibited by only one entity of the type in question, cannot be objectively modeled, so singlets are treated unobjectively as a special case.

Information-flow diagram FIG. 28 illustrates an objective rehistogram frequency geometric logarithmic probability predictor 28000 for use in rehistogram frequency log-anomaly estimator 24000 for behaviors whose event frequencies are expected to follow a geometric distribution across entities. As with the objective rehistogram frequency geometric linear probability probability predictor 27000 (See FIG. 27), the objective rehistogram frequency geometric logarithmic probability predictor differs from its biased counterpart 26000 (See FIG. 26) in excluding the entity in question from the statistics used to model the rehistogram. Because the objective probability predictor alters the rehistogram statistics in an entity-specific way, it cannot make use of pre-computed rehistogram models, instead needing to incorporate the modeling process. Thus the biased predictor is preferred in applications where speed is critical, while the objective predictor is preferred in applications where accuracy is paramount.

Objective rehistogram frequency geometric logarithmic probability predictor 28000 incorporates most of objective rehistogram frequency geometric linear probability probability predictor 27000. Frequency decrementer 16040 subtracts one (1) from input behavior entity frequency 6070—the total number of observed events instantiating the behavior in question, across all entities of the type in question—to yield behavior entity objective frequency 27010, while frequency subtractor 27020 subtracts observed behavior entity event frequency 5100 from total behavior event frequency 8060 to yield behavior event objective frequency 27030. Frequency decrementer 16040 subtracts one (1) from input behavior entity event frequency 5100, outputting the result as behavior continuation frequency 25010—denoting the subtraction of the termination event to yield the number of repetition continuations—the total number of entities of that type observed to instantiate that behavior.

Frequency divider 10010 divides behavior entity objective frequency 27010 by behavior event objective frequency 27030, outputting the result as behavior entity termination objective probability estimate 27040, which is equal to the reciprocal of the sample mean of the objective rehistogram. Probability complementer 10030 then takes the complement of the behavior entity termination objective probability estimate, outputting the result as behavior entity continuation objective probability estimate 27050, which is equal to the common ratio between the frequencies of successive frequencies in the geometric distribution presumed to underlie the objective rehistogram.

One instance of logarithm operator 11010 calculates the logarithm of the behavior entity termination objective probability 27040, outputting the result as behavior entity termination log objective probability 28010; while another instance of the logarithm operator calculates the logarithm of behavior entity continuation objective probability 27050, outputting the result as behavior entity continuation log objective probability 28020.

Log-probability multiplier 26010 multiplies behavior entity continuation log objective probability 28020 by behavior continuation frequency 25010 to yield behavior continuation frequency log objective probability 26020. Log-probability adder 26030 then adds the behavior continuation frequency log probability to behavior entity termination log objective probability 28010 to yield rehistogram frequency predicted log objective probability 28040—the total predicted log probability of the observed frequency of the behavior given the objective rehistogram.

In an alternative embodiment suitable for applications where accuracy is paramount and execution speed is not an issue, not shown here, the objectivity criterion is extended to integrity of the entire rehistogram, by beginning at the high-frequency tail and recursively discounting each anomalous entity to the extent that it is anomalous, ideally using floating-point instead of integer frequencies for increased precision.

Information-flow diagram FIG. 29 illustrates an entity anomaly evaluator 1120 for use in anomalous behavior detection system 1000 (See FIG. 1). Behavior×entity event frequency anomalies traverser 29010 steps through each observed combination of entity identifier 5070 and behavior identifier 2100 in behavior×entity event frequency anomalies 21080, where the entities are either sessions, subjects, or any other entity type required for the specific application; and behavior×entity event frequency anomalies is either behavior×session event frequency anomalies, or behavior×entity event frequency anomalies respectively. Entity behavior anomaly evaluator 29020 computes the entity anomaly score 1140 for each observed entity as the weighted sum of the anomalies of all observed behaviors for that entity, weighted by application-specific intrinsic entity threat values 29060 and behavior threat values 29100.

In greater detail, in behavior×entity event frequency anomalies traverser 29010, entity stepper 5060 steps through the anomalies in behavior×entity event frequency anomalies 21080, outputting each one as an entity identifier 5070. For each entity, behavior stepper 5050 steps through the set of behaviors for that entity in the behavior×entity event frequency anomalies, outputting each one as a behavior identifier 2100. In an embodiment, the entity stepper precedes the behavior stepper, as depicted here, to facilitate accumulating the behavior entity event frequency anomaly scores for each entity.

In an embodiment, if the set of actually observed entities of a given entity type is not given by the anomalies array itself, then entity stepper 5060 steps through only the actually observed entities as given by entity store 5080, which is either session store 2120 or subject store 2060, respectively. Likewise in embodiments wherein the set of actually observed behaviors is not immediately given by anomalies array 21080 itself, for example if the entity dimension of the anomalies array is represented as a linear array of all potentially observable entities of that type, in an embodiment behavior stepper 5050 steps through only the actually observed behaviors as given by behavior store 2090, rather than through all possible behaviors.

In entity behavior anomaly evaluator 29020, behavior entity event frequency anomaly fetcher 29030 fetches behavior entity frequency linear anomaly 23110 or behavior entity frequency log anomaly 24140 corresponding to input entity identifier 5070 and input behavior identifier 2100 from behavior×entity event frequency anomalies array 21080, depending on whether linear or log probabilities were computed and stored in the anomalies array. If the probabilities are linear, then logarithm operator 11010 converts them to logarithms to permit the individual anomalies to be summed rather than multiplied, and hence reduce the chance of underflow. Entity intrinsic threat value fetcher 29040 fetches the entity intrinsic threat value 29060 from application-specific entity intrinsic threat values table 29050. Log-probability multiplier 26010 multiplies the behavior entity event frequency log anomaly 24140 by the entity intrinsic threat value, outputting the result as entity-weighted behavior event frequency anomaly 29070. Similarly, behavior intrinsic threat value fetcher 29080 fetches the behavior intrinsic threat value 29100 from application-specific behavior intrinsic threat values table 29090. Another instance of log-probability multiplier 26010 multiplies entity-weighted behavior event frequency anomaly 29070 by the behavior intrinsic threat value, outputting the result as entity behavior anomaly score 29110. Finally, for each entity, log-probability adder 26030 sums the individual scores for all behaviors for that entity, outputting the result as entity anomaly score 1140.

As has been explained herein, a system for detecting anomalous recurrent behavior can use a variety of tools and approaches. Additional embodiments can be imagined by those of ordinary skill in the art after reading this disclosure. The exemplary arrangements of components given here are for illustrative purposes, and it should be apparent that the components can be rearranged, refactored, and modified in many different ways.

For example, the processes described herein may be implemented using hardware components, firmware components, software components, or any combination thereof. The specification and figures are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. A non-transitory computer readable storage medium, comprising executable instructions to:
observe the distribution of the frequency of a recurrent behavior to form a histogram;
compute a rehistogram of the histogram to model the distribution of the frequency of the frequency of the recurrent behavior, wherein the rehistogram provides an individual frequency relative to the total frequency of the recurrent behavior;
compare the individual frequency to a predicted frequency to form a difference frequency; and
identify an anomaly event when the difference frequency exceeds an anomaly threshold.

2. The non-transitory computer readable storage medium of claim 1 further comprising executable instructions to form a measure of the degree of anomaly as the ratio of the individual frequency and the predicted frequency, wherein the measure is an excess probability.

3. The non-transitory computer readable storage medium of claim 2 further comprising executable instructions to take the product of a plurality of excess probabilities to form a joint excess probability.

4. The non-transitory computer readable storage medium of claim 3 further comprising executable instructions to sum the logarithm of each excess probability of the plurality of excess probabilities.

5. The non-transitory computer readable storage medium of claim 4 further comprising executable instructions to normalize each excess probability.

6. The non-transitory computer readable storage medium of claim 5 wherein the executable instructions to normalize include executable instructions to accumulate individual excess probabilities of the plurality of excess probabilities.

7. The non-transitory computer readable storage medium of claim 1 further comprising executable instructions to form an overall anomaly value by only combining probabilities associated with anomaly events.

8. The non-transitory computer readable storage medium of claim 1 further comprising executable instructions to compare the rehistogram to a prior rehistogram associated with a prior behavioral cycle.

9. The non-transitory computer readable storage medium of claim 1 further comprising executable instructions to enable a subject recognizer to associate a subject with a recurrent behavior.

10. The non-transitory computer readable storage medium of claim 9 further comprising executable instructions to selectively disable the subject recognizer.

11. The non-transitory computer readable storage medium of claim 1 further comprising executable instructions to enable a behavior recognizer to characterize the recurrent behavior.

12. The non-transitory computer readable storage medium of claim 11 further comprising executable instructions to selectively disable the behavior recognizer.

13. The non-transitory computer readable storage medium of claim 1 further comprising executable instructions to enable a session segregator to associate the recurrent behavior with a session.

14. The non-transitory computer readable storage medium of claim 1 further comprising executable instructions to selectively disable the session segregator.

15. The non-transitory computer readable storage medium of claim 1 further comprising executable instructions to compute a behavior entity termination probability estimate as the reciprocal of the sample mean of the rehistogram.

16. The non-transitory computer readable storage medium of claim 15 further comprising executable instructions to take the complement of the behavior entity termination probability estimate to form a behavior entity continuation probability estimate.
